(19) United States
(12) Patent Application Publication
(10) Pub. No.: US 2012/0112503 A1
(43) Pub. Date: May 10, 2012

(54) VEHICLE SEAT

(75) Inventor: Eiji Masutani, Tochigi (JP)

(73) Assignee: TS TECH CO., LTD., Asaka-shi, Saitama (JP)

(21) Appl. No.: 13/318,745

(22) PCT Filed: May 21, 2010
(86) PCT No.: PCT/ES2010/058626

§ 371 Date: Nov. 3, 2011

(30) Foreign Application Priority Data
May 22, 2009 (JP) 2009-124034
Jun. 10, 2009 (JP) 2009-139369
Jun. 10, 2009 (JP) 2009-139384
Jun. 10, 2009 (JP) 2009-139665
Jun. 10, 2009 (JP) 2009-139670
Jun. 10, 2009 (JP) 2009-139672
Jun. 10, 2009 (JP) 2009-139673
Jun. 10, 2009 (JP) 2009-139690

(51) Int. Cl. B60N 2/427; B60R 22/46; B60R 22/195

(52) U.S. Cl. 297/216.1

(57) ABSTRACT

A vehicle seat is configured such that a seating surface of a seat bottom moves in response to a frontal collision as defined with respect to an occupant seated on the vehicle seat. The vehicle seat includes: a base frame of the seat bottom configured to be supported on a vehicle body; a movable frame 40 configured to be movable relative to the base frame; at least one driving force generator (second gas cylinder 61) configured to be activated in response to the frontal collision; and at least one driving force transmission member configured to transmit a driving force generated by the driving force generator. At least one of the driving force generator is arranged opposite to the movable frame 40, and the movable frame 40 has a recess portion 42A at a position opposite to the driving force generator.

### TECHNICAL FIELD

The present invention relates to a vehicle seat such as a car seat, and particularly to a vehicle seat having a seating surface configured to be moved in response to a frontal collision as viewed from an occupant.

### BACKGROUND ART

There is known a car seat having a seat bottom with a seating surface configured to be moved rearward in response to a frontal collision such that a car collides head-on against another car or other object. For example, a car seat disclosed in Patent Literature 1 has a pretensioner device (gas cylinder) disposed with its axis being oriented in a right-left direction, to thereby cause the seating surface to be moved rearward.

Further, as disclosed in Patent Literatures 1 and 2, the car seat has another pretensioner device for promptly pulling in a seatbelt in a frontal collision of the vehicle.

### CITATION LIST

### Patent Literatures

Patent Literature 1: Japanese Laid-open Patent Application, Publication No. 2008-213546
Patent Literature 2: Japanese Laid-open Patent Application, Publication No. 2008-195359

### SUMMARY OF THE INVENTION

### Technical Problem

Providing dedicated gas cylinders (driving force generators) separately in a vehicle seat for moving the seating surface and for pulling in the seatbelt in response to a frontal collision would result in an increased space requirement and thus be difficult to ensure installation space.

In view of this, the present invention seeks to provide a vehicle seat in which driving force generators for moving the seat surface and for pulling in the seatbelt in response to a frontal collision are arranged in a compact manner.

### Solution to Problem

According to a first aspect of the present invention, there is provided a vehicle seat configured such that a seating surface of a seat bottom moves in response to a frontal collision as defined with respect to an occupant seated on the vehicle seat, the vehicle seat comprising: a base frame of the seat bottom configured to be supported on a vehicle body; a movable frame configured to be movable relative to the base frame; at least one driving force generator configured to be activated in response to the frontal collision; and at least one driving force transmission member configured to transmit a driving force generated by the driving force generator, wherein at least one of the driving force generator is arranged opposite to the movable frame, and the movable frame has a recess portion or an opening at a position opposite to the driving force generator.

Preferably, the driving force generator may comprise a first driving force generator, and the driving force transmission member may comprise a first driving force transmission member configured to transmit a driving force generated by the first driving force generator to an occupant protection system.

Preferably, the driving force generator may comprise a second driving force generator, and the driving force transmission member may comprise a second driving force transmission member configured to transmit a driving force generated by the second driving force generator between the base frame and the movable frame, whereby the movable frame is moved relative to the base frame.

Preferably, the driving force generator may comprise a first driving force generator and a second driving force generator, and the driving force transmission member may comprise: a first driving force transmission member configured to transmit a driving force generated by the first driving force generator to an occupant protection system; and a second driving force transmission member configured to transmit a driving force generated by the second driving force generator between the base frame and the movable frame whereby the movable frame is moved relative to the base frame.

With this configuration of the vehicle seat according to the first aspect of the present invention, since the driving force generator is arranged opposite to the movable frame and a recess portion or an opening is provided in the movable frame at a position opposite to the driving force generator, the driving force generator can be positioned close to the movable frame while avoiding interference between the movable frame and the driving force generator. Therefore, a compact arrangement of the driving force generator can be realized.

According to a second aspect of the present invention, the vehicle seat of the aforementioned first aspect may be configured such that the driving force generator comprises: a first driving force generator configured to contract in response to a frontal collision and provided at a portion which is not moved in a front-rear direction by the frontal collision with its axis oriented in a right-left direction; and a second driving force generator configured to contract in response to the frontal collision and provided at the movable frame with its axis oriented in the right-left direction, and that the driving force transmission member comprises: a first wire configured to connect one end and the other end of the first driving force generator to a seatbelt anchor and an inner buckle respectively; and a second wire configured to connect one end and the other end of the second driving force generator to positions which are not moved in the front-rear direction by the frontal collision and which are disposed rearwardly of the second driving force generator, and further that the second driving force generator is disposed above the first driving force generator.

With this configuration, in addition to the above advantageous effects of the vehicle seat according to the first aspect, better wire arrangement of the first wire and the second wire is achieved and the two driving force generators can be arranged compactly because the second driving force generator for causing the seating surface to be moved rearward is disposed above the first driving force generator for pulling the seatbelt in a frontal collision of the vehicle.

In the vehicle seat according to the second aspect of the present invention, it is preferable that the second driving force generator is arranged frontwardly of the first driving force generator.

With this configuration, an upper front space of the seat bottom is used for the arrangement of the second gas cylinder and the first gas cylinder disposed rearwardly of the second gas cylinder is located in a relatively lower position, so that a large cushion stroke particularly required at a rear part of the seat bottom can be achieved.

In the vehicle seat according to the second aspect of the present invention, it is preferable that the movable frame is configured such that a front part thereof is moved upward when the movable frame is moved rearward relative to the base frame.

With this configuration, since the front part of the movable frame is raised upward in a frontal collision of the vehicle, the occupant is unlikely to slide off the seat bottom and the vehicle seat easily holds the occupant. Further, since the second driving force generator provided in the movable frame also moves rearward while being raised upward, interference between the first driving force generator and the second driving force generator hardly occurs. For this reason, it is possible that the first driving force generator and the second driving force generator are arranged relatively close to each other, so that they can be arranged compactly.

In the vehicle seat according to the second aspect of the present invention, it is preferable that each of the first driving force generator and the second driving force generator comprises a cylinder and a piston rod, and each cylinder is disposed in a position closer to one of right and left ends.

With this configuration, since the cylinder is disposed to one of right and left sides, a large amount of stroke of the piston rod can be achieved while reducing amplitude of vibration of each cylinder which is tensed by the first wire or the second wire.

According to a third aspect of the present invention, the vehicle seat of the aforementioned first aspect may be configured such that the movable frame comprises right and left side frames, and a pan frame made of sheet metal and configured to connect front end portions of the right and left side frames, and that the driving force generator is provided on the movable frame, and the driving force transmission member is configured to transmit a driving force generated by the driving force generator to a portion other than the movable frame, whereby the movable frame is moved relative to the base frame, and further that the vehicle seat further comprises a direction changing member attached to the side frame and configured to change a direction of a force applied from the driving force transmission member.

With this configuration, in addition to the above advantageous effects of the vehicle seat according to the first aspect, the direction changing member can stably operate because it is mounted on the movable frame comprising right and left side frames and a pan frame made of sheet metal, particularly to the side frame which has a rigidity higher than that of the pan frame. Therefore, even if a large driving force generated by the driving force generator is applied to the direction changing member via the driving force transmission member, the direction changing member can stably change the direction of the force applied from the driving force transmission member to ensure stability of the movement of the seating surface.

In the vehicle seat according to the third aspect of the present invention, it is preferable to comprise a reinforcement member configured to connect an attachment portion of the direction changing member and another portion to reinforce the attachment portion.

Providing the reinforcement member makes it possible to further stabilize the position of the direction changing member with respect to side frame, so that the stability of the movement of the seating surface can be further improved.

According to a fourth aspect of the present invention, the vehicle seat of the aforementioned first aspect may comprise first direction changing members provided separately at right and left sides and configured to change a direction of a force applied from the first driving force transmission member, and a reinforcement member configured to connect the right and left direction changing members.

With this configuration, in addition to the above advantageous effects of the vehicle seat according to the first aspect, the right and left direction changing members are connected by the reinforcement member. Therefore, even if each direction changing member is pulled inward in the right-left direction by the driving force transmission member, the reinforce member can prevent each direction changing member from being displaced from its normal position. Further, since the reinforce member can prevent displacement of each direction changing member, the pulling operation of the seatbelt can be stabilized by inhibiting deformation of the frame supporting the direction changing members.

In the vehicle seat according to the fourth aspect of the present invention, it is preferable that the first direction changing member is arranged in a space below the base frame.

With this configuration, since the first direction changing member is arranged in a space below the base frame, space can be effectively utilized and the size of the vehicle seat can be downsized.

According to a fifth aspect of the present invention, the vehicle seat of the aforementioned first aspect may be configured such that the movable frame has guide holes each formed in right and left side walls of the movable frame in such a manner as to extend in a front-rear direction along the side wall to guide a movement of the movable frame, and a connecting member configured to connect the right and left side walls of the movable frame, and that both ends of the connecting member are connected to the right and left side walls of the movable frame in positions above or below the guide holes.

With this configuration, in addition to the above advantageous effects of the vehicle seat according to the first aspect, since the both ends of the connecting member are connected to the right and left side walls of the movable frame in positions above or below the guide holes extending in the front-rear direction, the guide holes can be formed to have a maximum length to ensure a sufficient travel distance of the movable frame. Also, compared to a configuration in which both ends of the connecting member are connected to the right and left side walls of the movable frame in positions frontward or rearward of the guide holes, the length of the movable frame can be shortened, so as to reduce the amount of the movable frame to be extended beyond the seat by the displacement of the movable frame.

In the vehicle seat according to the fifth aspect of the present invention, it is preferable that the vehicle seat comprises attachment members respectively engageable with right and left side walls of the base frame, and that each attachment members is inserted into the guide hole, and the driving force transmission member is connected to the attachment member.

With this configuration, since each of the attachment members engageable with the base frame is inserted into the corresponding guide hole of the movable frame and the driving force transmission member is connected to the attachment member, it is not necessary that the base frame has a separate portion or a separate member for connecting the driving force transmission member such as a wire to the base frame. Therefore, the configuration of the base frame can be simplified and the number of assembly parts can be reduced.

In the vehicle seat according to the fifth aspect of the present invention, it is preferable that the connecting member is configured such that a center portion thereof curves from both end portions thereof in a direction away from the occupant.

With this configuration, since the center portion of the connecting member curves from both end portions of the connecting member in a direction away from the occupant siting on the seat, the occupant is less likely to experience an uncomfortable contact feeling.

According to a sixth aspect of the present invention, the vehicle seat of the aforementioned first aspect may further comprise: mounting brackets provided below and at right and left of the seat bottom so as to attach the seat bottom to the vehicle body; right and left height adjustment links pivotably connected to the right and left mounting brackets and pivotably connected to the base frame; and a connecting member configured to connect the right and left height adjustment links, wherein the connecting member is arranged below a moving trajectory of the movable frame.

With this configuration, in addition to the above advantageous effects of the vehicle seat according to the first aspect, since the connecting member for connecting the right and left height adjustment links is arranged below the moving trajectory of the movable frame, the movable frame can be moved without interruption. This makes it possible to realize a smooth movement of the movable frame (seating surface of the seat bottom).

In the vehicle seat according to the sixth aspect of the present invention, it is preferable that the vehicle seat further comprises: first and second driving force generators configured to be activated in response to the frontal collision; a first driving force transmission member configured to transmit a driving force generated by the first driving force generator to a seatbelt to pull in the seatbelt; first direction changing members provided at right and left of the first driving force generator and configured to change a direction of an applied force from the first driving force transmission member; a second driving force transmission member configured to transmit a driving force generated by the second driving force generator between the base frame and the movable frame to thereby cause the movable frame to move relative to the base frame; and second direction changing members provided at right and left of the second driving force generator and configured to change a direction of a force applied from the second driving force transmission member, and that the second direction changing members are disposed more inward in a right-left direction than the first direction changing members.

With this configuration, since the second direction changing members are disposed more inward in the right-left direction than the first direction changing members, the second direction changing members can be arranged compactly and a device for moving the seating surface (movable frame) can be downsized. This makes it possible to reduce the overall size of the vehicle seat.

According to a seventh aspect of the present invention, the vehicle seat of the aforementioned first aspect may further comprises seating surface position adjustment members each having one end portion pivotably connected to the movable frame and another end portion pivotably connected to the base frame, so that the seating surface position adjustment member is rotated when the movable frame is moved relative to the base frame. Further, the seating surface position adjustment members may be provided between side walls of the base frame and side walls of the movable frame.

With this configuration, in addition to the above advantageous effects of the vehicle seat according to the first aspect, the seating surface position adjustment member can be arranged compactly in a space between the side walls of the base frame and the side walls of the movable frame and these side walls prevent the seating surface position adjustment member from being completely exposed. Therefore, the seating surface position adjustment member is less likely to interfere with the seat cushion and a smooth operation of the seating surface position adjustment member can be realized.

In the vehicle seat according to the seventh aspect of the present invention, it is preferable that the driving force transmission member is disposed to extend in a front-rear direction between the side walls of the base frame and the side walls of the movable frame.

With this configuration, most part of the driving force transmission member is accommodated in a space between the side walls of the movable frame and the side walls of the base frame and compactly arranged therebetween. Further, since the driving force transmission member is less likely to interfere with the seat cushion because of these side walls, a smooth operation of the driving force transmission member can be realized.

In the vehicle seat according to the seventh aspect of the present invention, it is preferable that each side wall of the movable frame has an upper fringe portion and a lower fringe portion to form a U-shaped cross-section at a portion facing to the driving force transmission member or the seating surface position adjustment member.

With this configuration, each side wall of the movable frame has a U-shaped cross-section, which has a higher rigidity, and the driving force transmission member or the seating surface position adjustment member faces to a recess portion formed by the U-shaped cross-section, so that the driving force transmission member and the seating surface position adjustment member can be arranged compactly.

In the vehicle seat according to the seventh aspect of the present invention, it is preferable that each side wall of the base frame has an upper fringe portion and a lower fringe portion to form a U-shaped cross-section at a portion facing to the driving force transmission member or the seating surface position adjustment member.

With this configuration, each side wall of the base frame has a U-shaped cross-section, which has a higher rigidity, and the driving force transmission member or the seating surface position adjustment member faces to a recess portion formed by the U-shaped cross-section, so that the driving force transmission member and the seating surface position adjustment member can be arranged compactly.

According to an eighth aspect of the present invention, the vehicle seat of the aforementioned first aspect may be configured such that the occupant protection system is a seatbelt comprising a shoulder belt designed to secure a shoulder part to a waist part of the occupant sitting on the vehicle seat, and a lap belt designed to secure the waist part of the occupant, that the first driving force generator is a lap pretensioner device configured to apply a tension to the lap belt, and that the vehicle seat further comprises: a shoulder pretensioner device configured to apply a tension to the shoulder belt; a collision detector configured to detect a collision of a vehicle; a controller configured to output an operation start signal to the shoulder pretensioner device and the lap pretensioner device, respectively, when the collision detector detects a collision of the vehicle; and an output timing determination unit provided in the controller and configured to determine output timings for outputting the operation start signals based on a pulling force of the shoulder pretensioner device for pulling in the shoulder belt and a pulling force of the lap pretensioner device for pulling in the lap belt. Further, the shoulder pretensioner device and the lap pretensioner device may apply tensions to the shoulder belt and the lap belt based on the operation start signals determined by the output timing determination unit.

With this configuration, in addition to the above advantageous effects of the vehicle seat according to the first aspect, timings for pulling the shoulder belt and the lap belt can be set to different values where necessary based on the pulling capacities of the shoulder pretensioner device and the lap pretensioner device. Therefore, the shoulder belt and the lap belt can better secure the occupant against the seat in a collision of the vehicle.

Alternatively, in the vehicle seat according to the first aspect of the present invention, the occupant protection system may be a seatbelt comprising a shoulder belt designed to secure a shoulder part to a waist part of the occupant sitting on the vehicle seat, and a lap belt designed to secure the waist part of the occupant, and the first driving force generator may be a lap pretensioner device configured to apply a tension to the lap belt. Further, the vehicle seat may comprises: a shoulder pretensioner device configured to apply a tension to the shoulder belt; a collision detector configured to detect a collision of a vehicle; and a controller configured to output an operation start signal to the shoulder pretensioner device and the lap pretensioner device, respectively, when the collision detector detects a collision of the vehicle, and the shoulder pretensioner device may apply a tension to the shoulder belt based on the operation start signal, and the lap pretensioner device may apply a tension to the lap belt based on the operation start signal after initiation of an operation of the shoulder pretensioner device.

With this configuration, if the collision detector detects a collision of the vehicle, the shoulder pretensioner device starts to apply a tension to the shoulder belt, and thereafter, the lap pretensioner device initiates its operation. For this reason, in addition to the above advantageous effects of the vehicle seat according to the first aspect of the present invention, since the amount of the shoulder belt pulled by the shoulder pretensioner device is increased, the effective length of the shoulder belt can be decreased. Accordingly, the securing force of the shoulder belt by which the upper body of the occupant is secured on the seat in a collision of the vehicle can be improved. Further; since the lap pretensioner device operates after the shoulder pretensioner device applies a tension to the shoulder belt, the tension amount of the lap pretensioner device can be reduced. Therefore, since the tension amount of the lap pretensioner device with respect to the lap belt can be improved, the securing force of the lap belt by which the waist part of the occupant is secured in the collision of the vehicle can be improved.

As described above, according to the vehicle seat of the eighth aspect, play (slack) of the shoulder belt can be quickly removed with a simple configuration and the occupant is reliably secured to the seat in a collision of the vehicle.

In the vehicle seat according to the eighth aspect of the present invention, it is preferable that the occupant protection system further comprises a fastening state detector configured to detect a fastening state of the shoulder belt and the lap belt to the occupant, and the controller may determine a timing for initiating an operation of the lap pretensioner device in accordance with the fastening state of the shoulder belt and the lap belt detected by the fastening state detector.

With this configuration, if the occupant wears a thick cloth, the delay time of the lap pretensioner device for initiating the operation can be set to a longer time when compared with the case in which the occupant wears a thin cloth. Accordingly, since the delay time for causing the lap pretensioner device to initiate the operation is determined based on the fastening state of the shoulder belt and the lap belt, it is possible to more securely hold the occupant on the seat.

### BRIEF DESCRIPTION OF DRAWINGS

FIG. 1 is an overall perspective view of a seat frame of a car seat.

FIG. 2 is an exploded perspective view of a seat bottom of the seat frame.

FIG. 3 is a schematic view explaining positional relation between a rear link connecting pipe and a movable frame and explaining a height adjustment mechanism, in which (a) shows a lower seat position, and (b) shows a higher seat position.

FIG. 4 is a sectional view taken along the line Z-Z of FIG. 1.

FIG. 5 shows the movable frame as viewed from bottom.

FIG. 6 shows a link connecting pipe and a gas cylinder for a seat as viewed from front.

FIG. 7 is a top view explaining positional relation of sliders, a base frame, and the movable frame, when they are in a normal state.

FIG. 8 is a side view explaining positional relation of the sliders, the base frame, and the movable frame, when they are in the normal state.

FIG. 9 is a top view explaining positional relation of the sliders, the base frame, and the movable frame, when they are in a post-activation state.

FIG. 10 is a side view explaining positional relation of the sliders, the base frame, and the movable frame, when they are in the post-activation state.

FIG. 11 includes (a) a side view of the movable frame, and (b) a sectional view taken along the line X-X of (a).

FIG. 12 is a sectional view taken along the line Y-Y of FIG. 1.

FIG. 13 includes (a) a top view showing positional relation of pulleys, a reinforcement pipe, a first gas cylinder, and the sliders, and (b) an enlarged perspective view showing the structure around a bracket.

FIG. 14 shows the base frame and the movable frame as viewed from rear.

FIG. 15 is a perspective view showing a state in which pins are engaged with the base frame, rear links, an end portion of a second wire, and the movable frame.

FIG. 16 is a top view showing a state in which the pins are engaged with the base frame, the rear links, the end portion of the second wire, and the movable frame.

FIG. 17 is a top view of the seat bottom partly in section for explaining the arrangement of lifting links.

FIG. 18 shows a modification in which the first gas cylinder is arranged with its right and left sides reversed.

FIG. 19 is a sectional view showing the movable frame according to a modification.

FIG. 20 is a perspective view showing a car seat equipped with an occupant restraint system according to a second embodiment of the present invention.

FIG. 21 is a side view of a shoulder pretensioner device.

FIG. 22 is a front view of the shoulder pretensioner device.

FIG. 23 is a sectional view of a lap pretensioner device.

FIG. 24 is a sectional view showing a state before the lap pretensioner device initiates the operation.

FIG. 25 is a sectional view showing a state after the lap pretensioner device of FIG. 24 initiates the operation.

FIG. 26 is a sectional view showing another example of the lap pretensioner device.

FIG. 27 is an enlarged perspective view showing a main part of a cable guide of the lap pretensioner device.

FIG. 28 is a view showing an operational flow of the occupant restraint system.

FIG. 29 is a schematic top view of the car seat according to a first modification of the second embodiment, equipped with the lap pretensioner device and a seat-displacement pretensioner device.

FIG. 30 is a side view of FIG. 29.

FIG. 31 is a perspective view showing the seat-displacement pretensioner device and the seat fraise as viewed from rear of the vehicle.

FIG. 32 is a perspective view showing the seat-displacement pretensioner device and the seat frame as viewed from front of the vehicle.

FIG. 33 is a side view showing a state before the seat frame moves.

FIG. 34 is a side view showing a state after the seat frame has been moved.

FIG. 35 is a graph showing relation between the amount of the lap belt pulled by the lap pretensioner device in a collision of the vehicle and delay time from the initiation of the operation of the shoulder pretensioner device to the initiation of the operation of the lap pretensioner device.

FIG. 36 is a perspective view of the car seat equipped with the occupant restraint system, illustrating difference between pulling force applied by the shoulder pretensioner device and pulling force applied by the lap pretensioner device.

FIG. 37 is a perspective, view of the car seat equipped with the occupant restraint system, illustrating difference between pulling force applied by the shoulder pretensioner device and pulling force applied by the lap pretensioner device.

### DESCRIPTION OF EMBODIMENTS

### First Embodiment

With reference to the drawings, a first embodiment of the present invention will be described below.

### Overall Configuration

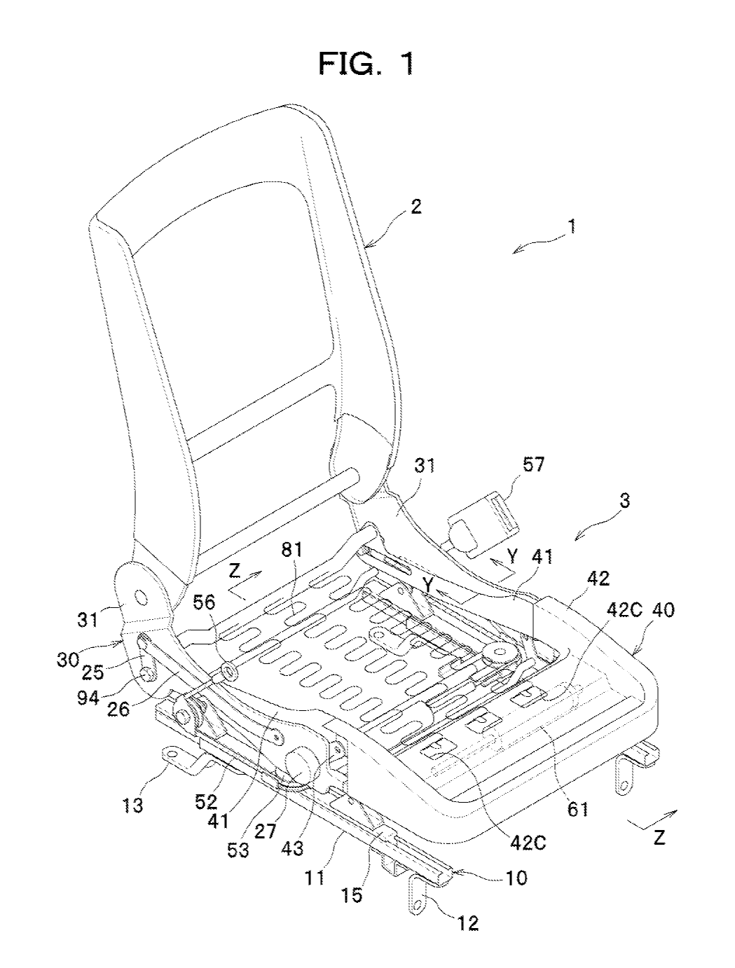

A car seat as an example of a vehicle seat of the present invention includes a seat frame 1 as shown in FIG. 1, and an outside of the seat frame 1 is covered with a seat cushion made of urethane foam or the like. The seat frame 1 includes a seat back frame 2 and a seat bottom frame 3. In describing the present invention, the front/rear, right/left and upper/lower (upward/downward) directions are designated as from the viewpoint of an occupant sitting on the seat.

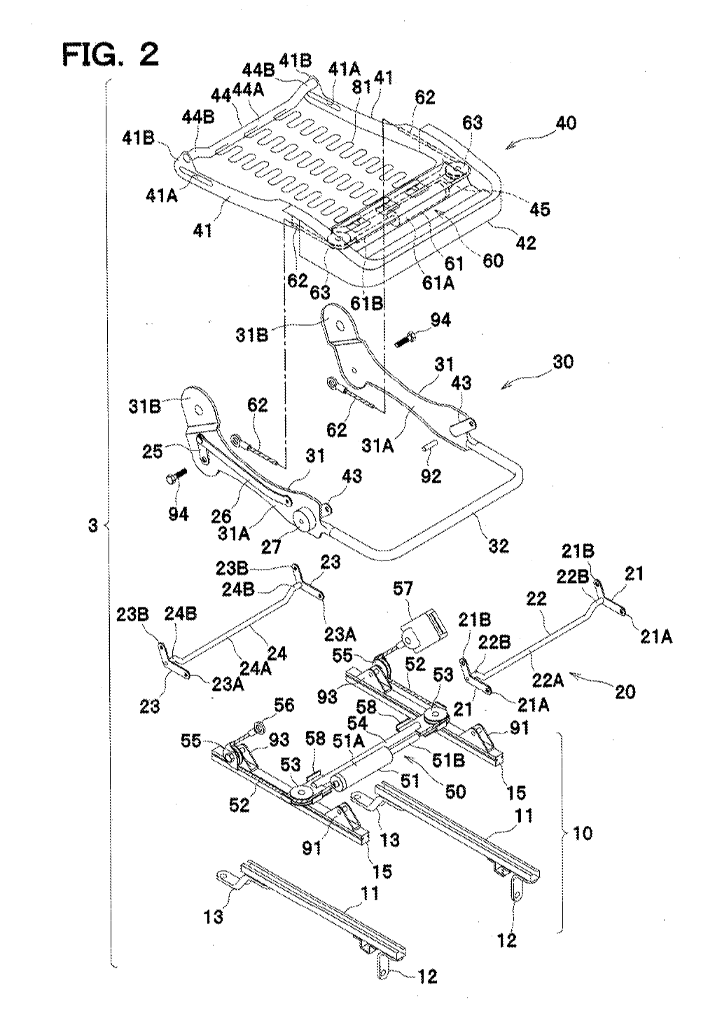

As shown in FIG. 2, the seat bottom frame 3 principally includes: a rail slider device 10 as an example of a mounting bracket configured to mount a seat bottom to a car body floor of a car body (one example of a vehicle body); a height adjustment mechanism 20 capable of adjusting the height of a seating surface; a base frame 30; a movable frame 40; a pretensioner device 50 configured to pull in a seatbelt as an example of an occupant protection system in a frontal collision which is defined by the occupant seated on the car seat; and a seating surface moving device 60 configured to cause the movable frame 40 to move rearward in a frontal collision. The movable frame 40 (seating surface of the seat bottom) is configured to be moved rearward relative to the base frame 30 in response to a frontal collision. In the following description, a state of the seat bottom frame 3 before activation of the pretensioner device 50 and the seating surface moving device 60 is referred to as a “normal state”, whereas a state of the seat bottom frame 3 after activation of the pretensioner device 50 and the seating surface moving device 60 by the frontal collision of the vehicle is referred to as a “post-activation state.” Unless otherwise stated, the following description explains the configuration of the car seat in the normal state.

It is to be noted that, according to this embodiment, the seat bottom mainly includes the base frame 30 and the movable frame 40.

The rail slider device 10 principally includes a pair of rails 11 and a pair of sliders 15. The rails 11, each having a shape elongated in the front-rear direction, are disposed in parallel separately at a right side and a left side. Each rail 11 is fixed to the car body floor (not shown) as an example of a vehicle body floor via a front bracket 12 and a rear bracket 13.

The sliders 15, each having a shape elongated in the front-rear direction, are provided at a right side and a left side as corresponding to the pair of right and left rails 11 and configured to be slidable along the rails 11. The sliders 15 are configured to support the base frame 30 with respect to the car body via the height adjustment mechanism 20.

In other words, the base frame 30 is supported on the car body of the vehicle via the height adjustment mechanism 20 and the rail slider device 10.

The height adjustment mechanism 20 includes front links 21 and rear links 23 as an example of height adjustment links. Lower end portions 21A of the front links 21 and lower end portions 23A of the rear links 23 are pivotably connected to the sliders 15, and upper end portions 21B of the front links 21 and upper end portions 23B of the rear links 23 are pivotably connected to the base frame 30, so that a four-bar linkage is formed which enables the base frame 30 to be moved upward and downward relative to the sliders 15.

To be more specific, two front links 21 are provided at the right side and at the left side, respectively, and the lower end portion 21A of each front link 21 is pivotably supported on a metal fitting 91 provided at a front end portion of the slider 15, so that each front link 21 is pivotably connected to the slider 15. The right and left front links 21 are connected by a front link connecting pipe 22 as an example of a link connecting member, with both ends of the front link connecting pipe 22 being fixed to center portions of the front links 21. With this front link connecting pipe 22, the right and left front links 21 are simultaneously rotated together.

The upper end portion 21B of each front link 21 is pivotably supported by a pin 92 (only one of the two pins 92 is shown in the figure), coaxially with a dial 27 provided at the base frame 30 to be described later in detail, so that the front link 21 is rotatably connected to the base frame 30.

Each front link 21 is located in a rearwardly tilting position such that the upper end portion 21B is positioned rearwardly of the lower end portion 21A.

The front link connecting pipe 22 is configured such that, a center portion 22A thereof, which corresponds to almost 70% of the length of the front link connecting pipe 22, curves so as to be positioned below both end portions 22B of the front link connecting pipe 22 in the normal state.

As with the front links 21, two rear links 23 are provided at the right side and at the left side, respectively, and the lower end portion 23A of each rear link 23 is pivotably supported on a metal fitting 93 provided at a rear end portion of the slider 15. The upper end portion 23B of each rear link 23 is engaged with a pin 94 (one example of an attachment member) which is rotatably engaged with the base frame 30 to be described later in detail, so that the rear link 23 is rotatably connected to the base frame 30. As with the front links 21, each rear link 23 is located in a rearwardly tilting position such that the upper end portion 23B is positioned rearwardly of the lower end portion 23A.

The right and left rear links 23 are connected by a rear link connecting pipe 24 as an example of a connecting member, with both ends of the rear link connecting pipe 24 being fixed to center portions of the rear links 23. With this rear link connecting pipe 24, the right and left rear links 23 are simultaneously rotated together.

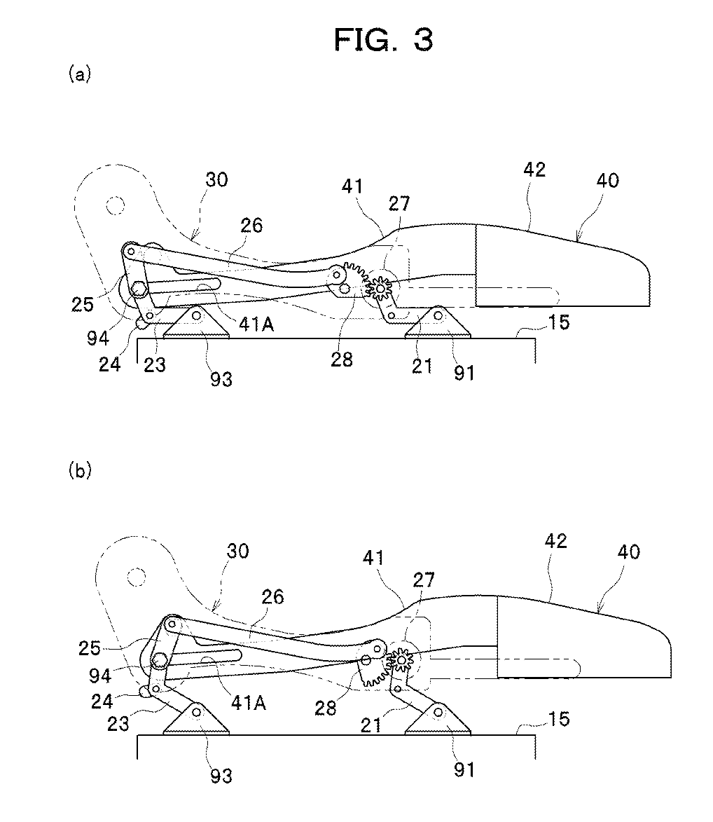

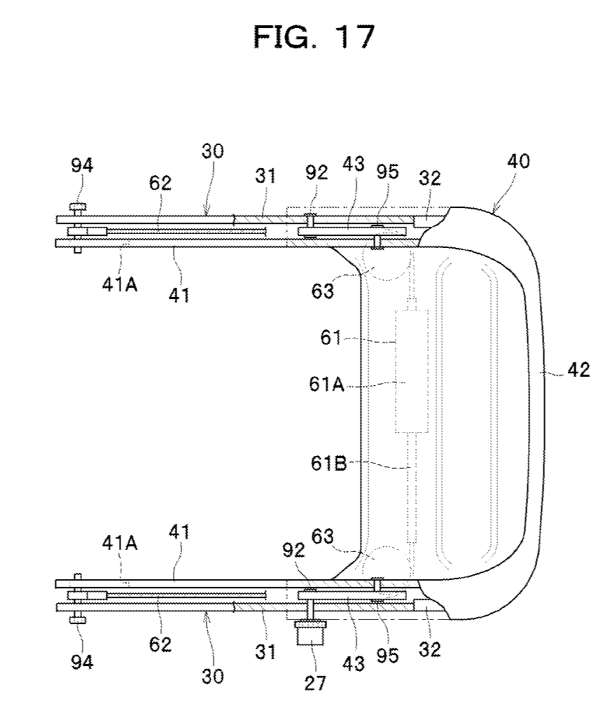

The rear link connecting pipe 24 is arranged below a moving trajectory starting from the normal state of the movable frame 40 to the post-activation state of the movable frame 40. With this arrangement, interference between the rear link connecting pipe 24 and the movable frame 40 can be prevented during the movement of the movable frame 40, and a smooth movement of the movable frame 40 (seating surface) can be realized. Further, in the normal state, the rear link connecting pipe 24 is arranged below right and left side frames 41 of the movable frame 40 and extends to intersect with the side frames 41 (see FIGS. 3 and 17). With this arrangement, a sufficient space for allowing the seat cushion and seat springs 81 to be deformed is created between the right and left side frames 41 of the movable frame 40, and the occupant seated on the car seat is less likely to experience an uncomfortable contact feeling. According to this embodiment, the rear link connecting pipe 24 is configured such that, a center portion 24A thereof, which corresponds to almost 70% of the length of the rear link connecting pipe 24 and faces to the seat springs 81, curves so as to be located below and rearwardly of the both end portions 24B of the rear link connecting pipe 24 in the normal state. This makes it possible to further reduce an uncomfortable contact feeling of the occupant.

The upper end portion 23B of each rear link 23 is engaged with the pin 94 in such a manner as to inhibit a relative rotation therebetween. The pin 94 is engaged with a link 25, which is provided on the base frame 30 and extends upward, at a lower end portion of the link 25 in such a manner as to inhibit a relative rotation therebetween. To be more specific, for example, the pin 94 has a two-side cut portion by which the rear link 23 and the link 25 engage with the pin 94. Engagement holes having substantially the same shape and size as that of the two-side cut portion are formed in the rear link 23 and the link 25, respectively. The pin 94 formed as described above and the engagement holes are brought into engagement with each other, so that a rotation of the pin 94 relative to the rear link 23 and the link 25 is inhibited. Accordingly, the rear link 23 and the link 25 are fixed so as not to change the angle between them.

Moreover, as shown in FIGS. 3(a) and 3(b), an upper end portion of the link 25 is pivotably coupled with an actuator link 26 extending toward the front side, and the actuator link 26 is pivotably coupled with a sector gear 28 which is rotatable with respect to the base frame 30. The dial 27 having a gear and operable to rotate the gear is provided at the base frame 30. The gear of the dial 27 and the sector gear 28 mesh with each other. Thus, as the dial 27 is operated to rotate, the rotation is transmitted to the sector gear 28, and causes the sector gear 28 to rotate. The rotation of the sector gear 28 is then transmitted via the actuator link 26 to the link 25, and causes the link 25 to rotate. Since the link 25 and the rear link 23 are fixed relative to each other at a prefixed angle by the pin 94, the motion of the link directly causes the rear link 23 to rotate. Further, since the rear link 23, the base frame 30 and the front link 21 form a four-bar linkage, when the rear link 23 is raised toward the front side, the front link 21 is also raised toward the front side to thereby cause the base frame 30 to be lifted up. In this way, the base frame 30 can be moved upward and downward by the normal and reverse rotation of the dial 27, whereby the height adjustment of the base frame 30 in the upward/downward direction can be made.

As shown in FIG. 2, the base frame 30 principally includes a pair of side frames 31 which form right and left sidewalls, and a connecting pipe 32 configured to connect front end portions of the right and left side frames 31.

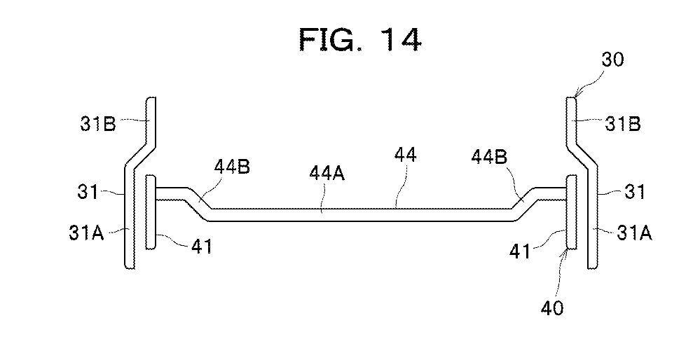

The right and left side frames 31 have opposite portions 31A arranged oppositely to sandwich the right and left side frames 41 of the movable frame 40, and attachment portions 31B protruding upward at rear end portions of the opposite portions 31A. As seen in FIG. 14, the opposite portions 31A curve outward, as viewed from rear, with respect to the attachment portions 31B. Accordingly, a space for receiving the movable frame 40 is obtained, and interference between the base frame 30 and the movable frame 40 can be avoided during the rearward displacement of the movable frame 40.

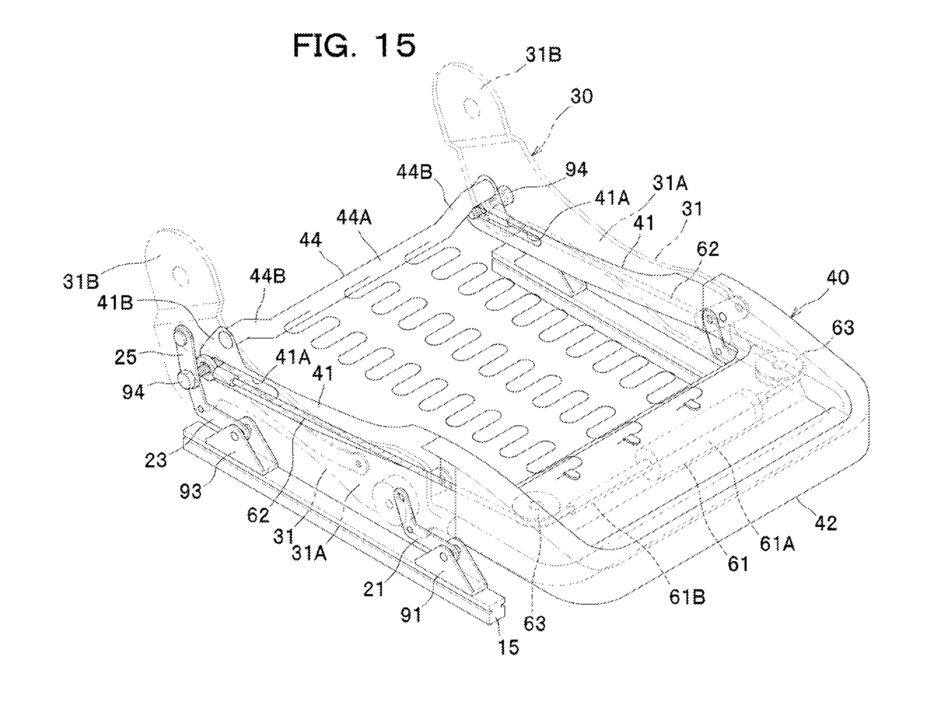

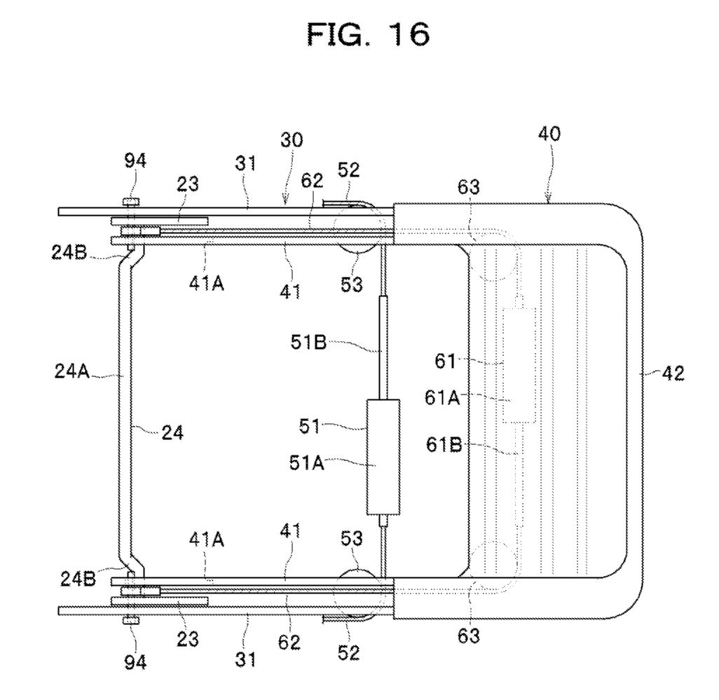

Turning now to FIG. 2, the pins 94 are pivotably engaged with the rear end portions of the right and left side frames 31 (opposite portions 31A), respectively (see also FIGS. 15 and 16). In this embodiment, the pin 94 is shaped like a hexagonal bolt.

The dial 27 is provided rotatably at the front end portion of the right side frame 31 (opposite portion 31A). At positions coaxial with the dial 27, lifting links 43 as an example of a seating surface position adjustment member are pivotably supported with their lower end portions (other end portions) being engaged with the pins 92. The lifting links 43 serve to lift the movable frame 40 when the movable frame 40 is moved rearward. In the normal state, each of the lifting links 43 is in a tilted position with its front end up about 45 degrees with respect to the horizontal. Upper end portions (one end portions) of the lifting links 43 are pivotably coupled with the side frames 41 of the movable frame 40 through pins 95 (see FIG. 17).

The pin 94 shaped like a hexagonal bolt is pivotably engaged with the rear end portion of each of the right and left side frames 31.

The seat back frame 2 is attached to the attachment portions 31B (see FIG. 1). In this embodiment, since the distance between the right and left attachment portions 31B is smaller than the distance between the right and left, opposite portions 31A, the base frame 30 and the seat back frame 2 can be downsized.

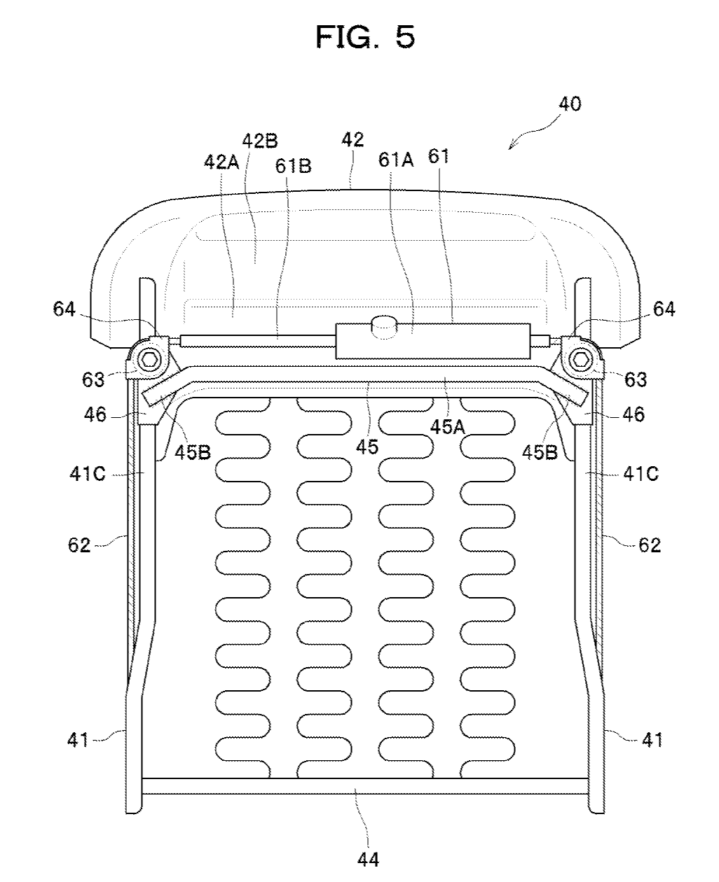

The movable frame 40 is disposed between the right and left side frames 31 of the base frame 30, and includes the pair of side frames 41 configured to form the right and left side walls, a pan frame 42 which is a cross member as an example of a front-side connecting member and configured to connect the front end portions of the right and left side frames 41, a connecting pipe 44 as an example of a rear-side connecting member configured to connect the rear end portions of the right and left side frames 41, a reinforcement pipe 45 as an example of a reinforcement member, and an attachment plate 46 (see FIG. 5).

A guide hole 41A extending in the front-rear direction is formed in the rear end portion of each side frame 41, and the pin 94 is inserted in the guide hole 41A. With this configuration, as the movable frame 40 is moved rearward relative to the base frame 30, the rear end portion of the movable frame 40 is moved along a direction of the length of the guide holes 41A.

According to this embodiment, since the movable frame 40 is located inside the base frame 30, it is possible to reduce the size and the weight of the movable frame 40 with respect to the base frame 30, so that a smooth movement of the movable frame 40 can be achieved.

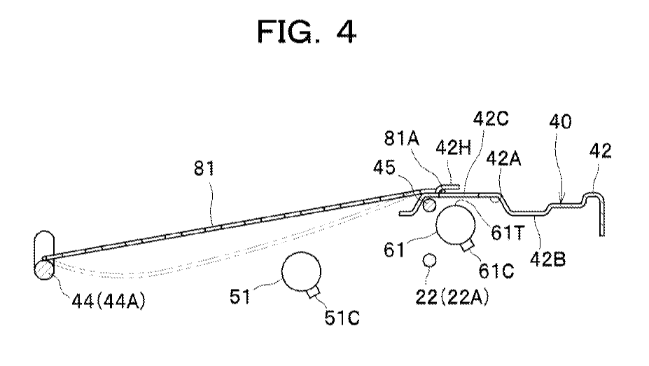

As seen in FIG. 4, the pan frame 42 is formed by press working sheet metal, and as viewed from bottom, the lower side of the pan frame 42 is formed to have a recess portion 42A which is recessed upward, and a protruding portion 42B protruding downward, in this order from the rear side. Hooks 42H formed by raising parts of the sheet metal and having a front end portion extending toward the front side are provided at an area of the upper surface of the pan frame 42 under which the recess portion 42A is located. Sheet springs 81 as an example of a spring member are provided in a tensioned state between the hooks 42H formed on the pan frame 42 and the connecting pipe 44. The front-most portions 81A of the sheet springs 81 are located rearwardly of the upper-most portion 61T of a second gas cylinder 61 to be described later in detail.

As seen in FIG. 2, the connecting pipe 44 is configured such that a center portion 44A thereof, which corresponds to almost 70% of the length of the connecting pipe 44, curves from both end portions 44B thereof in a direction away from the occupant. To be more specific, the connecting pipe 44 curves such that the center portion 44A thereof is located below the both end portions 44B. Each end portion 44B is connected to a protruding portion 41B protruding upward and provided right above the guide hole 41A extending at the rear end portion of the side frame 41. In other words, the connecting pipe 44 is positioned right above the guide holes 41A. With this arrangement of the connecting pipe 44, the guide holes 41A are positioned as rearward as possible to ensure a sufficient travel distance of the movable frame 40. Also, compared to a configuration in which both end portions 44B of the connecting pipe 44 are connected to front or rear sides of the guide holes 41A, the front-rear length of the side frame 41 can be shortened, so as to reduce the amount of the movable frame 40 to be extended beyond the seat by the rearward displacement of the movable frame 40.

In order to prevent the occupant from experiencing an uncomfortable contact feeling, it is necessary that the center portion 44A of the connecting pipe 44 be arranged at a predetermined position having a lower height. However, according to this embodiment, since the connecting pipe 44 curves such that the both end portions 44B thereof are positioned above the center portion 44A, the connecting pipe 44 can connect the right and left side frames 41 at positions right above the guide holes 41A and a sufficient rigidity of the movable frame 40 can be obtained while suppressing an uncomfortable contact feeling experienced by the occupant.

Further, since the both end portions 44B of the connecting pipe 44 are connected to the protruding portions 41B provided above the guide holes 41A, the rigidity of the side frames around the guide holes 41A can be enhanced and the attachment rigidity of the connecting pipe 44 can also be enhanced. Further, compared to a configuration in which the connecting pipe 44 connects the both end portions 44B at positions right below the guide holes 41A, an increase in the height of the movable frame 40, and thus an increase in the height of the whole car seat can be suppressed.

According to this embodiment, since the guide holes 41A are formed in the rear end portions of the side frames 41 and the connecting pipe 44 connects the side frames 41 at positions above the guide holes 41A, a sufficient legroom for an occupant seated on the rear seat can be obtained.

As seen in FIG. 5, the attachment plate 46 and the reinforcement pipe 45 connect pulleys 63 which are provided separately for right and left sides. The connecting pipe 45 extends in the right-left direction under the pan frame 42 from one end to the other end of the pan frame 42. The reinforcement pipe 45 has a center portion 45A which corresponds to almost 70% of the length of the reinforcement pipe 45 and extends straight in the right-left direction, and both end portions 45B slightly bent toward the rear side, that is, in a direction away from the second gas cylinder 61. Since the reinforcement pipe 45 is arranged with the whole part thereof being located within the recess portion 42 of the pan frame 42, it is possible to accommodate the reinforcement pipe 45 in an extremely compact manner while enhancing the rigidity of the movable frame 40 (see FIG. 4).

Each of the attachment plate 46 is made of a steel plate which is thicker than the pan frame 42 and the side frames 41; the steel plate is cut into a shape corresponding to the end portion 45B of the reinforcement pipe 45, and the both end portions 45B of the reinforcement pipe 45 are fitted onto the thus cut-out portions of the attachment plates 46 and welded together. Each attachment plate 46 extends from an acute-angled corner portion formed between the side frame 41 and the end portion 45B of the reinforcement pipe 45 to the rear of the reinforcement pipe 45, extending around the end portion 45B. The attachment plates 46 are welded to lower surfaces 41C of the side frame 41. Accordingly, the reinforcement pipe 45 connects the right and left side frames 41 via the attachment plates 46.

It is to be noted that the attachment plates 46 are not connected to the center portion 45A of the reinforcement pipe 45, but connected only to the both end portions 45B which are curved with respect to the center portion 45A.

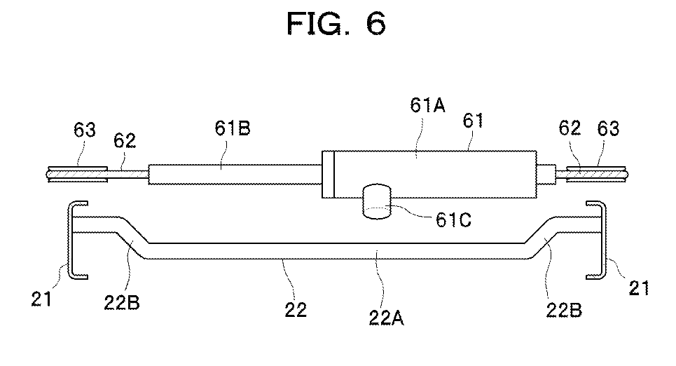

As seen in FIG. 6, front end portions of the lifting links 43 arranged separately at right and left sides are pivotably supported on the right and left side frames 41 of the movable frame 40 via the pins 95, whereas rear end portions of the lifting links 43 are pivotably supported on the right and left side frames 31 of the base frame 30 via the pins 92. Each lifting link 43 is disposed between the side frame 41 of the movable frame 40 and the side frame 31 of the base frame 30 in the right-left direction. Namely, each lifting link 43 is compactly arranged by efficiently using a space between the side frame 41 and the side frame 31. Further, since each of the lifting links 43 is disposed between the side frame 41 and the side frame 31, the lifting links 43 are less exposed from the seat frame 1. This can suppress interference of the lifting links 43 with the seat cushion or a car seat skin for covering the seat frame 1 to thereby provide a smooth operation.

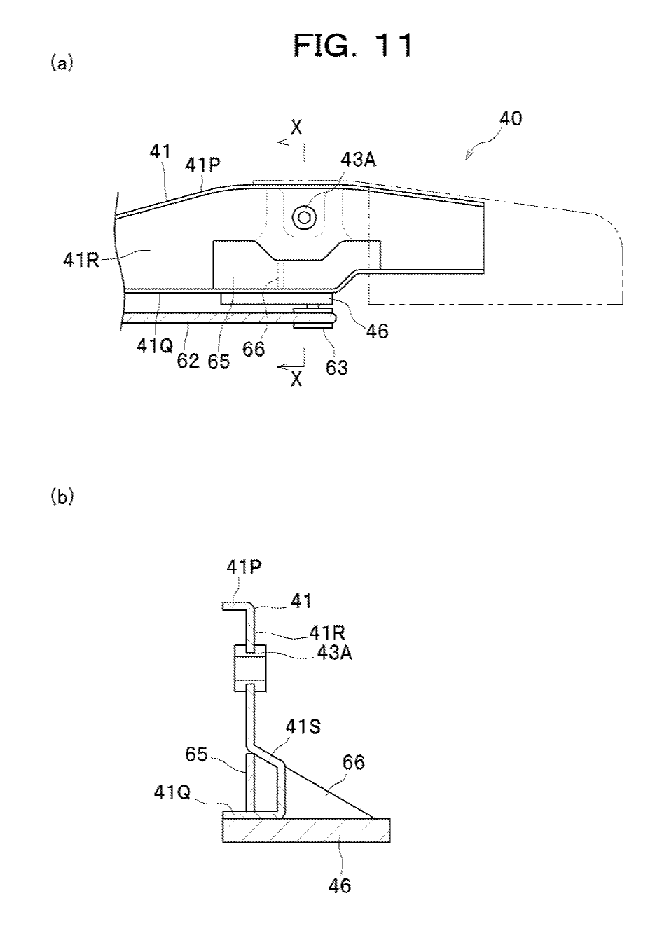

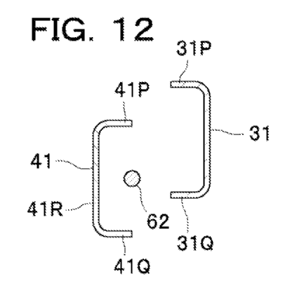

To explain the attachment rigidity of the pulleys 63 and the lifting links 43, as seen in FIG. 11 (a), each pulley 63 is fixed to the side frame 41 of the movable frame 40 via the attachment plate 46. As seen in FIG. 12, the side frame 41 includes a vertical portion 41R extending in the upper-lower direction, a flange 41P extending outward from an upper end of the vertical portion 41R, and a flange 41Q extending outward from a lower end of the vertical portion 41R, and roughly has a U-shaped section. Accordingly, the side frame 41 has a rigidity higher than the pan frame 42, and the pulley 63 has a higher attachment rigidity.

Each lifting link 43 is connected to a link attachment portion 43A of the vertical portion 41R, which is a bulging portion provided above the pulley 63 and bulging outward (sideward). Since the lifting links 43 and the pulleys 63 are attached to the side frames 41 having a higher rigidity, the attachment rigidities of the lifting links 43 and the pulleys 63 are high.

Further, as seen in FIGS. 11 (a) and (b), a reinforcement plate 65 is fixed by welding at an outer side surface of the vertical portion 41R, in a region corresponding to a dented portion 41S that is a partly and inwardly dented portion of the vertical portion 41R at a position below the link attachment portion 43A. The reinforcement plate 65 has a lower end portion connected to the flange 41Q which forms a part of an attachment portion for the pulley 63, and an upper end portion connected to an upper end portion of the dented portion 41S of the vertical portion 41R. With this configuration, the reinforcement plate 65 and the dented portion 41S form a closed section, so that the flange 41Q which forms a part of the attachment portion exhibits an enhanced rigidity. Further, since the reinforcement plate 65 is recessed at a center part of the upper edge portion corresponding to a peripheral bulging portion of the link attachment portion 43A, the bulging portion of the side frame 41 and the reinforcement plate 65 are continuously connected so that the rigidity of the link attachment portion 43A can be improved while preventing increase in size of the movable frame 40.

Further, a reinforcement rib 66 made of a thick steel plate is fixed by welding, bridging between the inner surface of the dented portion 41S and the upper surface of the attachment plate 46. Accordingly, the angle between the attachment plate 46 and the vertical portion 41R can be fixed, and the rigidity is extremely high at the attachment portion for the pulley 63 and at the link attachment portion 43A.

Further, the right and left attachment plates 46 are connected together by the reinforcement pipe 45 (see FIG. 1), which can also contribute to enhanced rigidities of the attachment plate 46 and the pulley attachment portion.

As described above, since each of the lifting links 43 is attached to the link attachment portion 43A which is a bulging portion bulging from the side frame 41 and is reinforced by the reinforcement plate 65, the reinforcement rib 66, the attachment plate 46, and the reinforcement pipe 45, the lifting links 43 have an extremely high attachment rigidity.

As described above, the side frame 41 has a rigidity higher than that of the pan frame. Further, in this embodiment, the side frame 41 has a thickness greater than that of the pan frame 42 and is made of a material having a rigidity higher than that of the pan frame 42. In particular, each of the side frames 41 constituting the movable frame 40 has the highest rigidity among the parts constituting the movable frame 40, so that a high attachment rigidity can be achieved at the pulleys 63 and the lifting links 43.

Further, since the pulley 63 is connected to a horizontal flange 41Q of the side frame 41 constituting the movable frame 40, better stability can be achieved after attachment of the pulley 63. Further, since the side frame 41 is less likely to be affected by the shape of the cushion as compared to the pan frame 42, it is easy to keep a flat surface area for the attachment of the pulley 63.

Further, since the rotation center of the pulley 63 is positioned frontward of the center attachment position of the link attachment portion 43A, it is easy to keep a sufficient travel distance of the movable frame 40 in the rearward direction and degree of design freedom for the fixing portion for the second wire 62 is increased. It is to be noted that the link attachment portion 43A and the pulley 63 may be arranged in the same position with respect to the front-rear direction.

As seen in FIG. 2, the pretensioner device 50 includes a first gas cylinder 51 as an example of a first driving force generator, a pair of first wires 52 as an example of a first driving force transmission member, two pulleys 53 as an example of a first direction changing member, the reinforcement pipe 54 as an example of a reinforcement member, and two pulleys 55.

As with the pretensioner device disclosed in Patent Literature 1, the first gas cylinder 51 includes a cylinder 51A, a piston (not shown) configured to move in the cylinder 51A, a piston rod 51B axially protruding from the piston to the outside of the cylinder 51A, and a gas generator 51C (see FIG. 4). The first gas cylinder 51 is arranged below (right down) and at a slightly frontward position of the seat springs 81 (see FIG. 4) with its axis oriented in the right-left direction. As shown by chain lines in FIG. 4, when the occupant sits on the seat bottom (seat), most of the load thereof is applied to the rear side of the seat springs 81 (seating surface), so that the seat springs 81 sag in a greater amount at the rear side and the front side of the seat springs 81 sag in a smaller amount. For this reason, the first gas cylinder 51 is disposed in a space just under the seat springs 81 and at the front side where the seat springs 81 sag in a smaller amount. This makes it possible to compactly arrange the first gas cylinder by efficiently using the space. Further, since the interference between the seat springs 81 and the first gas cylinder 51 can be avoided even when the seat springs 81 sag, it is possible to prevent the occupant from experiencing an uncomfortable contact feeling. It is to be noted that the front side of the seat springs 81 indicates a position more forward than the center portion of the seat springs 81.

An acceleration sensor (not shown) is connected to the gas generator 51C. When deceleration of the vehicle at a predetermined value or greater is detected by the acceleration sensor, an electric signal is input so that gas is supplied from the gas generator 51C into the cylinder 51A. This causes the piston rod 51B to move into the cylinder 51A, so that the first gas cylinder 51 as a whole contracts in the axial direction. As seen in FIG. 2, the cylinder 51A of the first gas cylinder 51 is connected to the seat belt anchor 56 via one of the first wires 52, and the piston rod 51B is connected to the inner buckle 57 via the other one of the first wires 52. To be more specific, a pulley 53 is provided at each of the two sliders 15 via a bracket 58 as an example of an attachment plate; the pulleys 53 are arranged at right and left sides of the first gas cylinder 51, respectively, and each configured to be rotatable about an axis extending in the upper-lower direction. The two first wires 52 connected to the cylinder 51A and the piston rod 51B extend outward to the right and to the left and then looped around the corresponding pulleys 53 and directed toward rearward (i.e., directions are changed). The two first wires 52 connected to the cylinder 51A and the piston rod 51B extend outward to the right and to the left and thereafter looped around the pulleys 53 to change their directions toward rearward. In other words, the first gas cylinder 51 is connected to the sliders 15 via the first wires 52 and the pulleys 53; more specifically, the first gas cylinder 51 is provided in a tensioned state between the two pulleys 53 fixed to the sliders 15 as a portion which is not moved in a front-rear direction by the frontal collision. In this embodiment, a portion which is moved in the front-rear direction by the frontal collision indicates the movable frame 40.

A pulley 55 is provided at each of the two sliders 15 via a metal fitting 93; the pulley 55 is configured to be rotatable about an axis extending in the right-left direction and fixed to the metal fitting 93 provided at the rear end portion of the slider 15. The two first wires 52 directed toward rearward are then looped around the pulleys 55 and directed toward a frontward and obliquely upward direction. Ends of the two first wires 52 are connected to the seatbelt anchor 56 and the inner buckle 57, respectively.

Right and left brackets 58 are connected by the reinforcement pipe 54. In other words, the right and left brackets 58 connect the reinforcement pipe 54 and the pulleys 53, and the right and left pulleys 53 are connected by the reinforcement pipe 54 via the brackets 58.

With this configuration, even when a strong tension applied to the two first wires 52 impels the right and left pulleys 53 to move closer to each other, the reinforcement pipe 54 stretched against the brackets 58 (pulleys 53) withstands this impelling force, so that the distance between the right and left sliders 15 (pulleys 53) can be maintained properly.

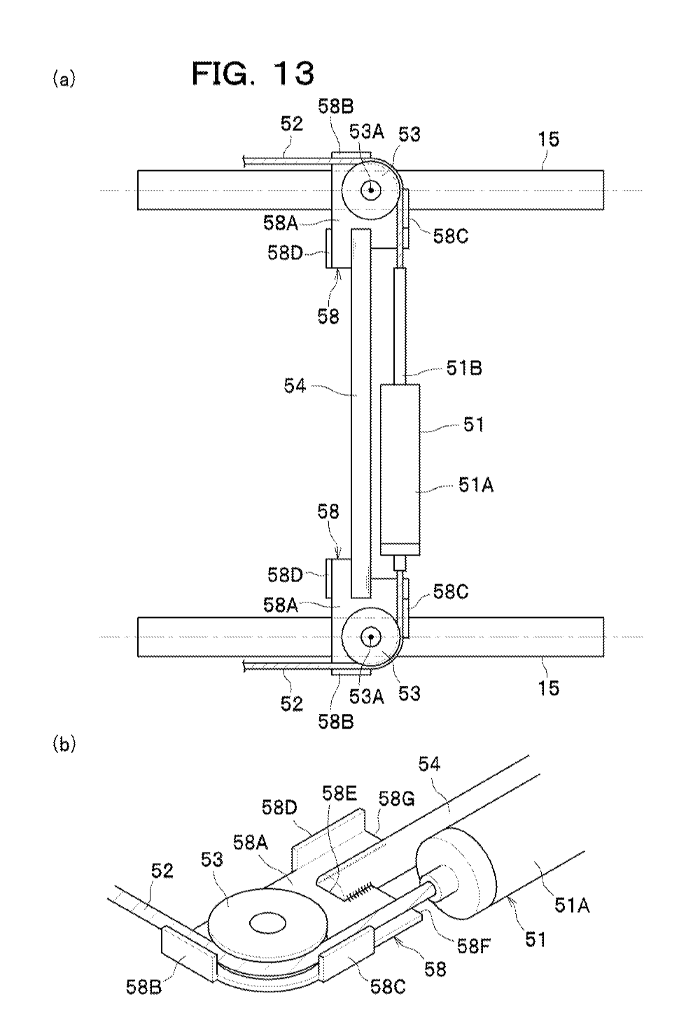

To more specifically explain the positional relation between the above-described parts, as seen in FIG. 13 (a), the pulleys 53 are arranged at right and left of the first gas cylinder 51, and the rotation center 53A of each pulley 53 is located in the center of the width of the slider 15 (as shown by alternate long and short dash lines in the figure). Therefore, the slider 15 can stably support the pulley 53. Further, compared to a configuration in which the rotation center 53A of the pulley 53 is located outwardly in the width direction of the slider 15 (located outside the alternate long and short dash lines in the figure), the amount of the pulley 53 to be extended beyond the outer surface of the slider 15 in the width direction thereof can be reduced, which contributes to reduction in the size. Furthermore, the pulley 53 is arranged in a space below the base frame 30 (see FIG. 1). This makes it possible to realize a compact arrangement by efficiently using the space.

The reinforcement pipe 54 is provided along and rearwardly of the first gas cylinder 51 (at the pulley 53 side). To be more specific, the reinforcement pipe 54 is provided close to the line connecting the center portions (rotation centers 53A) of the pulleys 53. Therefore, for example, compared to a configuration in which the front ends of the brackets 58 are connected by the reinforcement pipe such that the reinforcement pipe is arranged frontwardly of the first gas cylinder 51, it is possible to compactly arrange the right and left pulleys 53, the first gas cylinder 51, and the reinforcement pipe 54 in the front-rear direction.

In terms of rigidity, it is preferable that the reinforcement pipe 54 is arranged between the rotation centers 53A of the pulleys 53. However, as the size of the pulleys 53 becomes smaller for the compact arrangement, interference between the first gas cylinder 51 and the reinforcement pipe 54 is likely to occur. For this reason, the reinforcement pipe 54 is arranged away from the line connecting the rotation centers 53A of the pulleys 53 in a direction remote from the first gas cylinder 51, so as to maintain high rigidity as well as to reduce the size.

As seen in FIG. 13 (b), the bracket 58 includes a plate-like main body portion 58A for rotatably supporting the pulley 53, a first flange 58B, a second flange 58C, and a third flange 58D.

A dented portion 58E that is dented outward in the right-left direction is formed in right and left inner fringe portions of the main body portions 58A. The reinforcement pipe 54 is fitted into the dented portions 58E, and the dented portions 58E and the reinforcement pipe 54 are joined together by welding. The inner fringe portion of the main body portion 58A has a fringe 58F positioned frontwardly of the dented portion 58E; the fringe 58F is formed to provide a relief receded (i.e., to be located) farther outwardly in the right-left direction than a fringe 58G positioned rearwardly of the dented portion 58E. The relief can prevent interference with the first gas cylinder 51.

With this arrangement, a sufficiently large space for locating the first gas cylinder 51 can be maintained in the right-left direction, and lengths of the cylinder 51A and the piston rod 51B can be enlarged. This makes it possible to increase the stroke of the piston rod 51B to thereby increase the amount of the seatbelt to be pulled by the first gas cylinder 51. Further, the fringes 58G are positioned more inward in the right-left direction than the fringes 58F, namely, front and rear fringes for forming the dented portion 58E are formed such that the rear fringe is longer than the front fringe. Since the rear side of the reinforcement pipe 54 is welded to the dented portion 54E along a longer length range, the dented portion 54E and the reinforcement pipe 54 can be fixed firmly.

In order to have the first flange 58B facing to the pulley 53 supported on the main body portion 58A in the right-left direction, the first flange 58B is formed by bending to extend upwardly from an outer edge of the main body portion 58A, which is positioned outward in the right-left direction. Accordingly, the first flange 58B prevents the first wire 52 from being disengaged from the pulley 53 outwardly in the right-left direction.

In order to have the second flange 58C facing to the pulley 53 in the front-rear direction, the second flange 58C is formed by bending to extend upwardly from the front end of the main body portion 58A at an outer position in the right-left direction. Accordingly, the second flange 58C prevents the first wire 52 from being disengaged from the pulley 53 in the frontward direction.

The third flange 58D is formed by bending to extend upwardly from the rear end of the main body portion 58A at an inner position in the right-left direction. Accordingly, the rigidity of the main body portion 58A can be enhanced at a region where the dented portion 58E is formed because of the third flange 58D.

As seen in FIG. 2, the seating surface moving device 60 includes a second gas cylinder 61 as an example of a second driving force generator (driving force generator), a pair of second wires 62 as an example of a second driving force transmission member (driving force transmission member), and two pulleys 63 as an example of a second direction changing member (direction changing member). As with the first gas cylinder 51, the second gas cylinder 61 includes a cylinder 61A, a piston, a piston rod 61B, and a gas generator 61C (see FIG. 6). The second gas cylinder 61 is arranged with its axis oriented in the right-left direction. In other words, the second gas cylinder 61 is arranged parallel to the first gas cylinder 51. The cylinder 61A is connected, via one of the second wires 62, to the left-side pin 94 that is a portion which is not moved in the front-rear direction by the frontal collision (any member independent of the movable frame 40) and positioned rearwardly of the second gas cylinder 61 per se. The piston rod 61B is connected, via the other one of the second wires 62, to the right-side pin 94 that is a portion which is not moved in the front-rear direction by the frontal collision and positioned rearwardly of the second gas cylinder 61. The two second wires 62 extending out from the cylinder 61A and the piston rod 61B are respectively looped around the two pulleys 63 separately and outwardly provided in the right-left direction of the second gas cylinder 61 and then directed toward the two pins 94 provided rearward.

As seen in FIG. 5, the pulley 63 is provided on the attachment plate 46. With this configuration, even when the second gas cylinder 61 is activated and a strong tension applied to the two second wires 62 impels the right and left pulleys 63 to move closer to each other, the reinforcement pipe 45 stretched against the right and left attachment plates 46 withstands this impelling force, so that the positions of the pulleys 63 can be maintained. The pulley 63 is provided with a wire retainer 64 made of a metal plate; the wire retainer 64 has a plurality of claws projecting around the periphery of the pulley 63 with a slight space between them. Accordingly, it is possible to prevent the second wire 62 looped around the pulley 63 from coining off the pulley 63.

As seen in FIG. 12, each second wire 62 directed toward rearward by the pulley 63 extends in the front-rear direction and disposed in a space between the side frame 31 of the base frame 30 and the side frame 41 of the movable frame 40. This makes it possible to compactly arrange the rearwardly extending second wire 62 as well as to prevent interference between the seat cushion to be covered on the frames and the second wire 62. In particular, according to this embodiment, the second wire 62 is disposed in a region surrounded by flanges 31P, 31Q extending inwardly from the upper and lower ends of the side frame 31 and flanges 41P, 41Q (upper fringe portion and lower fringe portion) extending outwardly from the upper and lower ends of the side frame 41. Therefore, the second wire 62 is less likely to go out of the side frames 31, 41, so that interference with an external member can be appropriately prevented. Further, since the side frame 41 has a U-shaped cross-section, it can provide a higher rigidity and a stable movement of the movable frame 40.

As seen in FIG. 4, the second gas cylinder 61 is arranged under the pan frame 42 (movable frame 40) and opposite to the recess portion 42A of the pan frame 42. The pan frame 42 has the recess portion 42A at a position opposite to the second gas cylinder 61. In other words, the second gas cylinder 61 is arranged under the pan frame 42 and opposite to the recess portion 42A. Since the second gas cylinder 61 is arranged under the pan frame 42 at a position opposite to the recess portion 42A, the second gas cylinder 61 is less likely to interfere with the pan frame 42 even if the second gas cylinder 61 vibrates to some extent and the second gas cylinder 61 can be arranged compactly as close as possible to the pan frame 42. In particular, since the second gas cylinder 61 is arranged such that part of the upper portion of the second gas cylinder 61 enters the recess portion 42A, the second gas cylinder 61 can be accommodated in an extremely compact manner.

In the case where the second gas cylinder 61 is arranged under the plate-like pan frame 42, it may be difficult to check the attachment state of the second gas cylinder 61. However, in terms of improving workability, it is preferable that the attachment state of the second gas cylinder 61 is readily checked. To this end, according to this embodiment, openings 42C are formed at positions opposite to the second gas cylinder 61 of the pan frame 42 (in a bottom surface of the recess portion 42A; see also FIG. 1). Accordingly, since the attachment state of the second gas cylinder 61 is readily and visually checked from above the pan frame 42, the workability can be improved. In particular, according to this embodiment, since a plurality of openings 42C are formed along the axial direction of the second gas cylinder 61 as shown in FIG. 1, it is possible to more readily check the attachment state. Further, in this embodiment, since the upper-most portion 61T of the second gas cylinder 61 is located frontwardly of the front-most portions 81A of the seat springs 81, the seat springs 81 do not cover the openings 42C. Therefore, it is possible to more readily check the attachment state.

As seen in FIG. 6, in relation to the front link connecting pipe 22, the second gas cylinder 61 is arranged opposite to the center portion 22A of the front link connecting pipe 22 that is located in a lower position. Further, as seen in FIG. 4, the second gas cylinder 61 is arranged above and frontwardly of the center portion 22A of the front link connecting pipe 22. Changing the viewpoint, it can be said that the center portion 22A of the front link connecting pipe 22 curves downward in accordance with the travel range of the second gas cylinder 61.

Accordingly, when the movable frame 40 moves rearward in the front collision of the vehicle, the interference of the front link connecting pipe 22 with the second gas generator 61 and the gas generator 61C protruding frontward and downward from the second gas cylinder 61 can be prevented, so that a smooth movement of the movable frame 40 can be achieved.

To explain the positional relations of the front link connecting pipe 22, the first gas cylinder 51 and the second gas cylinder 61, the first gas cylinder 51 is arranged rearwardly of the front link connecting pipe 22, and the second gas cylinder 61 is arranged frontwardly of the front link connecting pipe 22. Therefore, the three cylindrical members are separately disposed in the front-rear direction, which can avoid making the volume too bulky in height clue to provision of these members.

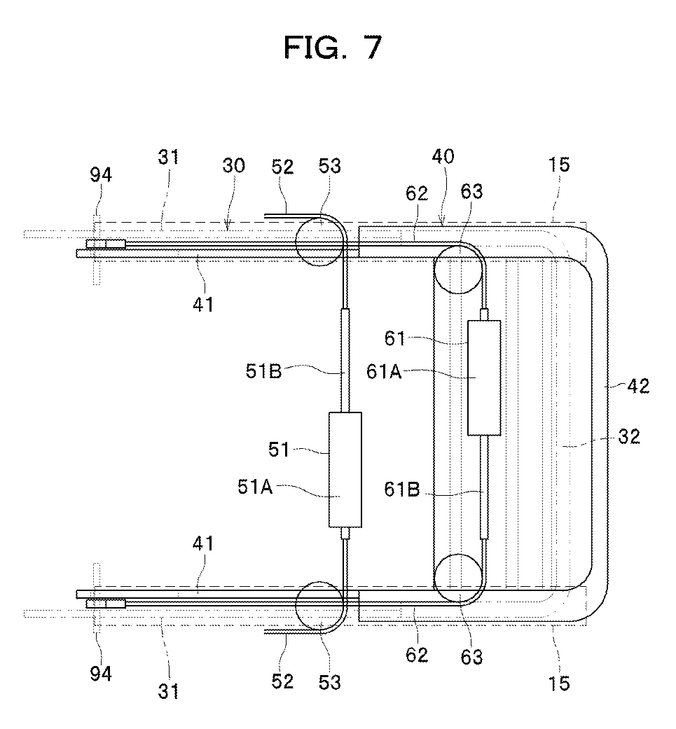

As seen in FIGS. 2 and 7, the first gas cylinder 51 and the second gas cylinder 61 are arranged such that the piston rods 51B extending outwardly from the first gas cylinder 51 and the piston rod 61B extending outwardly from the second gas cylinder 61 are oriented reversely in the right-left direction. To be more specific, the first gas cylinder 51 is arranged between the two pulleys 53 provided separately at right and left sides such that the cylinder 51A is located closer to the right end whereas the piston rod 51B extends leftward from the left end of the cylinder 51A. The second gas cylinder 61 is arranged between the two pulleys 63 provided separately at right and left sides such that the cylinder 61A is located closer to the left end whereas the piston rod 61B extends rightward from the right end of the cylinder 61A. Accordingly, the first gas cylinder 51 and the second gas cylinder 61 are less likely to interfere with each other even when the cylinders 51A, 61A which are thicker portions vibrate, and the right and left layout balance of weight becomes excellent. Further, when the first gas cylinder 51 and the second gas cylinder 61 operate, movements of the centers of gravity of the first and second gas cylinders 51, 61 are canceled out by each other and any unnecessary force is not applied to the seat bottom. Further, since the cylinder 51A and the cylinder 61A are disposed closer to the right and left ends, respectively, a large amount of stroke of the piston rod 61B can be achieved.

To explain the positional relation between the pulleys 53 and the pulleys 63, as seen in FIG. 16, the pulleys 63 are disposed more inward in the right-left direction than the pulleys 53. To be more specific, the right and left pulleys 63 are arranged such that the distance from the outer-most portion of one of the pulleys 63 to the outer-most portion of the other one of the pulleys 63 in the right-left direction is set to be smaller than the distance from the outer-most portion of one of the pulleys 53 to the outer-most portion of the other one of the pulleys 53. Therefore, the pulleys 63 can be arranged compactly, so that the seating surface moving device 60 can be downsized.

As seen in FIGS. 15 and 16, the pin 94 is non-rotatably engaged with the link 25, rotatably engaged with the rear end portion of each right and left side frame 31 of the base frame 30, and non-rotatably engaged with the rear link 23. The end portion of the second wire 62 is connected to the pin 94, and the pin 94 is inserted into the guide hole 41A formed in the rear end portion of each right and left side frame 41 of the movable frame 40. Accordingly, the pin 94, which is one part, has various functions: of providing a nodal point for assembling the link 25, the base frame 30, the rear link 23 and the movable frame 40 together; of guiding the movement of the movable frame 40; of fixing the end portion of the second wire 62; of connecting (fixing) the rear link 23 and the link 25 together; and rotatably connecting the base frame 30 with the rear link 23 and the link 25.

Namely, according to this embodiment, since the pin 94 as one part has multiple functions as described above, the frame structure of the car seat can be simplified and the number of assembly parts can be reduced as compared to the configuration in which parts and/or portions are individually and separately provided for providing the above various functions.

### Operation

Operation of the car seat configured as described above will be described.

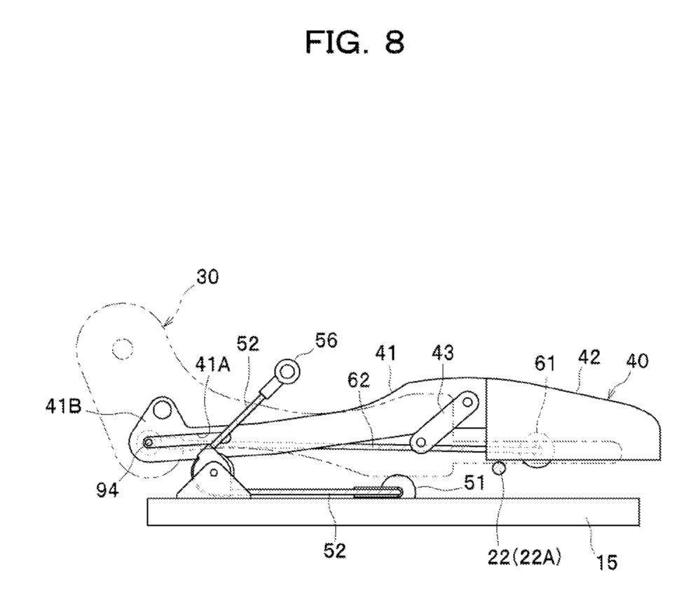

As seen in FIGS. 7 and 8, in the normal state, the movable frame 40 is located at a suitable position with respect to the base frame 30, in which position the occupant can normally sit on the car seat (position which is more frontward than that in the post-activation state) and the lifting links 43 are tilted with their front ends up about 45 degrees with respect to the horizontal. The cylinder 51A of the first gas cylinder 51 is located at the right end between the pulleys 53, and the cylinder 61A of the second gas cylinder 61 is located at the left end between the pulleys 63.

It is to be noted that, in FIGS. 7 through 10, the sliders 15, the base frame 30 and the movable frame 40 are shown in an overlapped manner, and these parts are illustrated using different lines for the purpose of easily distinction. For a similar reason, the first gas cylinder 51, the first wires 52, the pulleys 53, the second gas cylinder 61, the second wires 62 and the pulleys 63 are illustrated by solid lines.

When deceleration at a predetermined value or greater occurs in the event of a frontal collision of the vehicle, the acceleration sensor (not shown) outputs a signal to activate the gas generators 51C, 61C. In response, the first gas cylinder 51 and the second gas cylinder 61 are activated to contract, so that the cylinders 51A, 61A and the piston rods 51B, 61B move and pull the first wires 52 and the second wires 62 inwardly in the right-left direction. Consequently, the driving forces of the first gas cylinder 51 and the second gas cylinder 61 are transmitted to the seatbelt and the base frame 30, respectively.

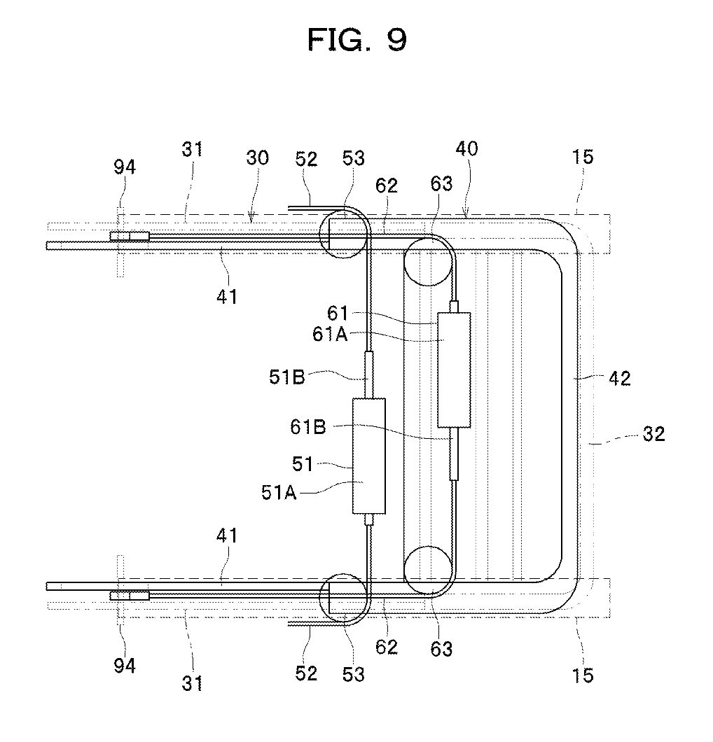

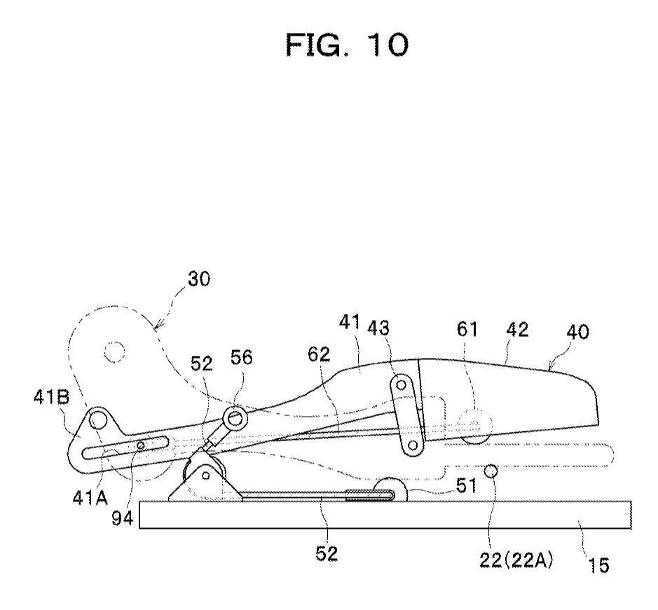

As seen in FIGS. 9 and 10, when the cylinders 51A, 61A and the piston rods 51B, 61B move and the first wires 52 are pulled, the pulleys 53 change the direction of a force applied by the first wires 52 into the front-rear direction, so that the seatbelt anchor 56 and the inner buckle 57 are pulled in. This can cause the seatbelt to tightly fasten the waist part of the occupant to thereby prevent the occupant from sliding off the car seat.

Further, when the second wires 62 are pulled, the pulleys 63 change the direction of a force applied by the second wires 62 into the front-rear direction. This causes the pins 94 (base frame 30) connected to the second wires 62 to be pulled with respect to the movable frame 40, so that the movable frame 40 (seating surface) moves rearwardly with respect to the base frame 30. Dining this time, the rear end portion of the movable frame 40 moves with the guide holes 41A guided by the pins 94. Since the front portion of the movable frame 40 is supported to the base frame 30 via the lifting links 43, the lifting links 43 rotate rearward as the movable frame 40 moves rearwardly, so that the front portions of the lifting links 43 are raised upward and the front part of the movable frame 40 is accordingly lifted up along the moving trajectory followed by the front portions of the lifting links 43. In this way, the seating surface on the cushion (not shown) is moved rearward and the front portion thereof is raised upward, so that the occupant who is thrust frontward by the inertia is readily received by the seating surface and the occupant is less likely to slide off the car seat.

### Advantageous Effects

The following advantageous effects can be achieved by the aforementioned car seat according to this embodiment.

Since the second gas cylinder 61 is arranged opposite to the pan frame 42 (movable frame 40) and the recess portion 42A is provided in the pan frame 42 at a position opposite to the second gas cylinder 61, the second gas cylinder 61 can be positioned close to the pan frame 42 while avoiding interference between the pan frame 42 and the second gas cylinder 61. Therefore, a compact arrangement of the second gas cylinder 61 can be realized.

In particular, since part of the upper portion of the second gas cylinder 61 enters the recess portion 42A, the second gas cylinder 61 can be positioned closer to the movable frame 40. Therefore, a more compact arrangement of the second gas cylinder 61 can be realized.

Since the reinforcement pipe 45 extending from one of the right and left sides of the movable frame 40 (pan frame 42) to the other side is arranged with the whole part thereof being located within the recess portion 42A, it is possible to arrange the reinforcement pipe 45 in an extremely compact manner while enhancing the rigidity of the movable frame 40.

Since the front link connecting pipe 22 is configured such that the center portion 22A thereof curves so as to be positioned below the both end portions 22B, interference between the front link connecting pipe 22 and the second gas cylinder 61 can be avoided and the front link connecting pipe 22 and the second gas cylinder 61 can be arranged in a compact manner.

Since the first gas cylinder 51 is disposed below the seat springs 81 at a position closer to the front side where the seat sprints 81 sag in a smaller amount when the occupant sits on the seat bottom, the first gas cylinder 51 can be compactly arranged by efficiently using the space. Further, since the interference between the first gas cylinder 51 and the seat springs 81 can be avoided, it is possible to prevent the occupant from experiencing an uncomfortable contact feeling.

Since the second gas cylinder 61 for causing the seating surface to be moved rearward is disposed above the first gas cylinder 51 for pulling the seatbelt in a frontal collision of the vehicle, better wire arrangement of the first wires 52 and the second wires 62 is achieved and the two gas cylinders 51, 61 can be arranged in a compact manner.

Since the upper front space of the seat bottom is used for the arrangement of the second gas cylinder 61 and the first gas cylinder 51 disposed rearwardly of the second gas cylinder 61 is located in a relatively lower position; a large cushion stroke particularly required at the rear part of the seat bottom, namely, a large space for allowing the seat springs 81 to sag downward, can be obtained.

Since the front part of the movable frame 40 is raised upward in a frontal collision of the vehicle, the occupant is unlikely to slide off the seat bottom and the car seat easily holds the occupant. Further, since the second gas cylinder 61 provided in the movable frame 40 also moves rearward while being raised upward, interference between the first gas cylinder 51 and the second gas cylinder 61 hardly occurs. For this reason, it is possible that the first gas cylinder 51 and the second gas cylinder 61 are arranged relatively close to each other, so that they can be arranged compactly.

Further, the first gas cylinder 51 and the second gas cylinder 61 are disposed separately in the front-rear direction with respect to the front link connecting pipe 22 connecting the right and left front links 21, which can avoid making the volume too bulky in height due to provision of these parts.

Since the interference between the cylinders 51A, 61A of the two gas cylinders can be prevented and movements of the centers of gravity of the two cylinders 51A, 61A made in the frontal collision occur reversely at right and left sides, any unnecessary force is not applied to the seat bottom.

Since each of the cylinders 51A, 61A is disposed to one of right and left sides, a large amount of stroke of the piston rod 51B, 61B can be achieved while reducing amplitude of vibration of each cylinder 51A, 61A which is tensed by the first wire 52 or the second wire 62.

Since the front link connecting pipe 22 is configured such that the center portion 22A thereof curves so as to be positioned below the both end portions 22B, interference between the front link connecting pipe 22 and the second gas cylinder 61 can be avoided and the front link connecting pipe 22 and the second gas cylinder 61 can be arranged in a compact manner.

Since each pulley 63 is attached to one of the side frames 41 of the movable frame 40, which has a higher rigidity, the attachment rigidity of the pulley 63 can be improved. For this reason, the pulley 63 stably operates, and even if a large tension of the wires 62 is applied to the pulleys 63, the pulleys 63 can stably change the direction of the force applied from the wires 62 to ensure stability of the movement of the seating surface.

Since the reinforcement plate 65, the reinforcement rib 66, the attachment plate 46 and the reinforcement pipe 45 are provided as a reinforcement member for reinforcing the attachment portion of the pulley 63, the attachment rigidity of the pulley 63 can be further enhanced.

In particular, since the both ends of the reinforcement pipe 45 extending in the right-left direction are connected to the attachment plates 46 and the pulley 63 is attached to each attachment plate 46, even when the second gas cylinder 61 is activated and a strong tension applied to the second wires 62 looped around the pulleys 63 impel the pulleys 63 to move closer to each other, the reinforcement pipe 45 stretched against the attachment plates 46 withstands this impelling force, so that the positions of the pulleys 63 can be maintained. Therefore, the second wires 62 operate stably and the stability of the movement of the seating surface can be ensured.

Since the attachment plates 46 are provided at acute-angled corner portions formed by bending the both end portions of the reinforcement pipe 45, the pulleys 63 can be compactly arranged by efficiently using the space. Since the attachment plates 46 are connected only to the both end portions 45B of the reinforcement pipe 45, which are curved portions of the reinforcement pipe 45, a more compact arrangement of the pulleys 63 and the attachment plates 46 can be realized.

The second wires 62 can, be arranged compactly using the space between the side frames 41 of the movable frame 40 and the side frames 31 of the base frame 30, and the second wires 62 are not exposed from the side frames 31, 41. This can suppress unintentional contact between the seat cushion and the second wires 62 to thereby provide a stable movement of the seating surface by the second wires 62.

Since the front link connecting pipe 22 is configured such that the center portion 22A thereof curves so as to be positioned below the both end portions 22B, interference between the front link connecting pipe 22 and the second gas cylinder 61 can be avoided and the front link connecting pipe 22 and the second gas cylinder 61 can be arranged in a compact manner.

Since the right and left pulleys 53 are connected by the reinforcement pipe 54, even if the pulleys 53 are pulled inward in the right-left direction by the first wires 52, the reinforcement pipe 54 can prevent each of the pulleys 53 from being displaced from its normal position. Further, since the reinforcement pipe 54 can prevent displacement of each pulley 53, the pulling operation of the seatbelt can be stabilized while inhibiting deformation of the sliders 15 for supporting the pulleys 53.

Since the reinforcement pipe 54 is provided rearwardly of the first gas cylinder 51 (at the pulley 53 side), it is possible to compactly arrange the right and left pulleys 53, the first gas cylinder 51 and the reinforcement pipe 54 in the front-rear direction.

Since the first gas cylinder 51 is provided on the sliders 15 via the first wires 52 and the pulleys 53, even when the sliders 15 are slid along the rails 11 for adjusting the front-rear position of the car seat, the positional relations between the first gas cylinder 51 and the pulleys 53 and the like do not vary. Therefore, the pulling operation of the seatbelt upon collision of the vehicle can be more stabilized.

Since the rotation center 53A of each pulley 53 is located in the center of the width of the slider 15, the slider 15 can stably support the pulley 53. Further, compared to the configuration in which the rotation center 53A of the pulley 53 is located outwardly in the width direction of the slider 15, the amount of the pulley 53 to be extended beyond the outer surface of the slider 15 in the width direction thereof can be reduced, which contributes to reduce the size.

Since the front link connecting pipe 22 is configured such that the center portion 22A thereof curves so as to be positioned below the both end portions 22B, interference between the front link connecting pipe 22 and the second gas cylinder 61 can be avoided and the front link connecting pipe 22 and the second gas cylinder 61 can be arranged in a compact manner.

Since the both end portions 44B of the connecting pipe 44 are located in positions above the guide holes 41A extending in the front-rear direction, the guide holes 41A can be formed to have the maximum length to ensure a sufficient travel distance of the movable frame 40. Also, compared to the configuration in which the both end portions 44B of the connecting pipe 44 are connected to the right and left side walls in positions frontward or rearward of the guide holes 41A, the length of the movable frame 40 (side frames 41) can be shortened, so as to reduce the amount of the movable frame 40 to be extended beyond the seat by the displacement of the movable frame 40.

Since each pin 94 engaged with the base frame 30 is inserted into the corresponding guide hole 41A of the movable frame 40 and connected to one end of the second wire 62, it is not necessary that the base frame 30 has a separate member or the like for connecting the end of the second wire 62. Therefore, the configuration of the base frame 30 can be simplified and the number of assembly parts of the car seat can be reduced.

Since the connecting pipe 44 is configured such that the center portion 44A thereof curves from the both end portions 44B in a direction away from the occupant siting on the car seat, the occupant is less likely to experience an uncomfortable contact feeling.

Since the both end portions 44B of the connecting pipe 44 are connected to the protruding portions 41B provided above the guide holes 41A, it is possible to improve the rigidity around the guide holes 41A and the attachment rigidity of the connecting pipe 44.

Since the base frame 30 (side frame 31) is configured such that the opposite portions 31A thereof curve outward, as viewed from rear, with respect to the attachment portion 31B, interference between the base frame 30 and the movable frame 40 can be avoided during the rearward displacement of the movable frame 40. Further, since the distance between the attachment portions 31B is smaller than that between the opposite portions 31A, the base frame 30 and the seat back frame 2 can be downsized.

Since the rear link connecting pipe 24 for connecting the right and left rear links 23 is arranged below the moving trajectory of the movable frame 40, the movable frame 40 can be moved without interruption. This makes it possible to realize a smooth movement of the movable frame 40 (seating surface of the seat bottom).

Since the pulleys 63 are disposed more inward than the pulleys 53, the pulleys 63 can be arranged compactly. Therefore, the seat bottom frame 3 (car seat) can be downsized.

Since the pins 94 for pivotably connecting the right and left rear links 23 to the base frame 30 are inserted into the corresponding guide holes 41A formed in the movable frame 40, it is not necessary to provide a separate portion or a separate member for guiding the movement of the movable frame 40. Therefore, the configuration of the base frame 30 can be simplified and the number of assembly parts of the car seat can be reduced.

Since the second wires 62 for transmitting the driving force of the second gas cylinder 61 to the base frame 30 are connected to the pins 94, it is not necessary that the base frame 30 has a separate portion or a separate member for connecting the second wires 62. Therefore, the configuration of the base frame 30 can be further simplified and the number of assembly parts can be reduced.

Since the lifting links 43 are arranged compactly using the space between the side frames 31 and the side frames 41, and the lifting links 43 are not completely exposed because of these side frames 31, 41, the lifting links 43 are less likely to interfere with the seat cushion and a smooth operation of the lifting links 43 can be achieved.

Since most part of the second wires 62 is accommodated in the space between the side frames 31 and the side frames 41, it is possible to compactly arrange the second wires 62 using a free space. Further, since the second wires 62 surrounded by the side frames 31, 41 are less likely to interfere with the seat cushion or the car seat skin, a smooth operation of the second wires 62 can be realized.

Each side frame 41 of the movable frame 40 has flanges 41P, 41Q to thereby form a U-shaped cross-section, which provides a higher rigidity, and the second wire 62 faces to the dented portion of the side frame 41. Therefore, the second wires 62 can be arranged compactly.

Each side frame 31 of the base frame 30 has flanges 31P, 31Q to thereby form a U-shaped cross-section, which provides a higher rigidity, and the second wire 62 faces to the dented portion of the side frame 31. Therefore, the second wires 62 can be arranged compactly.

### Modified Embodiments

Although the first embodiment of the present invention has been described above, the present invention is not limited to this embodiment and may be carried out into practice in various other ways, as will be described below.

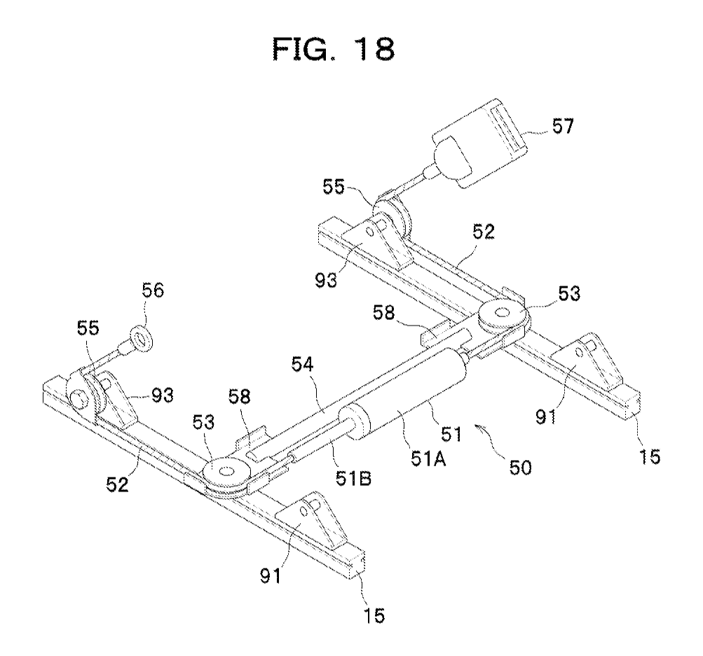

For example, in the above embodiment, the cylinder 51A of the first gas cylinder 51 is disposed at the right side. However, this arrangement may be reversed such that, as seen in FIG. 18, the cylinder 51A is disposed in a position closer to the left side, that the first wire 52 connected to the cylinder 51A is connected to the inner buckle 57, and that the first wire 52 connected to the piston rod 51B is connected to the seatbelt anchor 56. With this configuration, the inner buckle 57, which is difficult to promptly pull in because the seatbelt from the shoulder part and the seatbelt for the waist part are connected together, is connected to the cylinder 51A with a small amount of stroke, whereas the seatbelt anchor 56, which is easy to pull in, is connected to the piston rod 51B with a large amount of stroke. Therefore, it is possible to efficiently fasten the seatbelt for wrapping around the waist part of the occupant.

In the above embodiment, part of the upper portion of the second gas cylinder 61 (driving force generator) enters the recess portion 42A. However, the present invention is not limited to this arrangement, and the whole part of the driving force generator may be located within the recess portion. Further, in the above embodiment, the whole part of the reinforcement pipe 45 (reinforcement member) is located within the recess portion 42A. However, the present invention is not limited to this arrangement, and part of the reinforcement member may enter the recess portion.

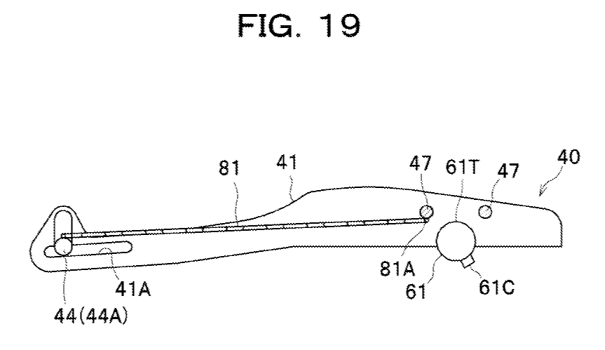

In the above embodiment, the pan frame 42 formed by press working sheet metal is adopted by way of example as the front-side connecting member. However, the front-side connecting member is not limited to this pan frame 42, and for example, a tubular or columnar connecting pipe 47 for connecting the right and left side frames 41 of the movable frame 40 such as shown in FIG. 19 may be employed.

In the above embodiment, the movable frame 40 (pan frame 42) has the recess portion 42A at a position opposite to the second gas cylinder 61. However, the present invention is not limited to this arrangement, and the movable frame 40 may have at least one opening at a position opposite to the second gas cylinder 61. Such an opening may be a through-hole formed in the plate-like pan frame 42, or instead, as seen in FIG. 19, a space formed between two connecting pipes 47 for connecting the right and left side frames 41.

According to the configuration shown in FIG. 19, the front end portions of the seat springs 81 are attached to the rear-side connecting pipe 47 at positions under the rear-side connecting pipe 47, and the second gas cylinder 61 is disposed opposite to the opening formed between the two connecting pipes 47. The upper-most portion 61T of the second gas cylinder 61 is located frontwardly of the front-most portions 81A of the seat springs 81. Accordingly, the second gas cylinder 61 can be compactly arranged, while maintaining a gap between the second gas cylinder 61 and the seat springs 81 so as to avoid interference of the seat springs 81 with the second gas cylinder 61 even when the seat springs 81 sag.

In the above embodiment, the second gas cylinder 61 is arranged under the movable frame 40 at a position opposite to the movable frame 40. However, the present invention is not limited to this arrangement, and the second gas cylinder 61 may be arranged above the movable frame 40 at a position opposite to the movable frame 40. In this case, the opening as described above or a recess portion, which is recessed downward as viewed from above, is formed at a position opposite to the second gas cylinder 61.

Further, the second gas cylinder 61 may be provided either in the movable frame 40 or in the base frame 30. In the case where the second gas cylinder 61 is provided in the base frame 30, it is preferable that one end and the other end of the second wire 62 extending out from the second gas cylinder 61 are connected to any portions of the movable frame 40.

In the above embodiment, the second gas cylinder 61 for displacing the seating surface (movable frame 40) of the seat bottom is disposed at a position opposite to the recess portion 42A of the movable frame 40. However, the present invention is not limited to this arrangement, and the first gas cylinder 51 for pulling in the seatbelt may be disposed at a position opposite to the recess portion (or opening) of the movable frame 40.

In the above embodiment, cylindrical pipes (the rear link connecting pipe 24, the connecting pipe 44, and the front link connecting pipe 22) are adopted by way of example as the rear-side connecting member and the link connecting member. However, the present invention is not limited to this specific configuration, and a circular or rectangular solid-columnar connecting member may be employed.

In the above embodiment, the first wires 52 extending from the both ends (the cylinder 51A and the piston rod 51B) of the first gas cylinder 51 are connected to the ends of the seatbelt (the seatbelt anchor 56 and the inner buckle 57). However, the present invention is not limited to this specific configuration, and the first wires 52 may be connected to intermediate portions of the seatbelt so that the intermediate portions are pulled when the first gas cylinder 51 is activated.

In the above embodiment, the gas cylinders 51, 61 are arranged with their axes oriented in the right-left direction. However, the present invention is not limited to this specific arrangement. For example, the axes of the gas cylinders 51, 61 may be oriented in the front-rear direction. Further, the axes of the gas cylinders 51, 61 may be oriented in different directions.

In the above embodiment, the second gas cylinder 61 is arranged at the movable frame 40 (under pan frame 42). However, the second gas cylinder 61 may be arranged at the base frame 30. In this case, one end and the other end of the second wire 62 extending out from the second gas cylinder 61 may be connected to any portions of the movable frame 40. This makes it possible to transmit the driving force of the second gas cylinder 61 to the movable frame 40.

In the above embodiment, the gas cylinder is adopted by way of example as the driving force generator. However, the present invention is not limited to this specific arrangement. For example, a spring or a motor may be used, instead.

In the above embodiment, wires are adopted by way of example as the driving force transmission member. However, the present invention is not limited to this specific configuration. For example, chains or rods may be used, instead.

In the above embodiment, the rotatable pulleys 53, 63 are adopted by way of example as a member (direction changing members) for changing the direction of the force applied from the first wires 52 or the second wires 62. However, the present invention is not limited to this specific configuration. For example, non-rotatable direction changing members each having a circular cylindrical surface, around which the wire or the like is looped, may be adopted. As an alternative, tubular direction changing members each having an inner portion for inserting the wire or the like may be adopted.

Further, in the above embodiment, the pins 94 are pivotably engaged with the base frame 30. However, the pins may be non-pivotably engaged. In this instance, pins may be prismatic columnar pipes or prismatic columnar rods.

In the above embodiment, linear seat springs 81 are adopted by way of example as the spring member. However, the present invention is not limited to this specific configuration, and plate-like spring members may be used, instead.

In the above embodiment, the both ends 44B of the connecting pipe 44 (rear-side connecting member) are connected to portions above the guide holes 41A. However, the present invention is not limited to this specific configuration. The both ends 44B of the connecting member may be connected to portions below the guide holes and the connecting member may be positioned right below the guide holes. According to this configuration, even if the center portion of the connecting member does not curve downward, the occupant is less likely to experience an uncomfortable contact feeling.

In the above embodiment, the hexagonal bolt-shaped pins 94 are adopted by way of example. However, the present invention is not limited to this specific configuration, and for example, circular cylindrical pipes or circular cylindrical rods may be used.

In the above embodiment, the movable frame 40 becomes movable with respect to the base frame 30 because the guide holes 41A formed in the movable frame 40 slide along the pins 94 engaged with the base frame 30. However, the present invention is not limited to this specific configuration. For example, at least the base frame may be fixed to the vehicle body so as not to be moved in a frontal collision of the vehicle, and the movable frame may be moved along rails provided on the vehicle body.

In the above embodiment, the movable frame (seating surface of the seat bottom) moves rearward in the frontal collision of the vehicle. However, the present invention is not limited to this specific configuration. For example, the front-part of the seat bottom may be lifted up or the rear-part of the seat bottom may be lowered in the frontal collision of the vehicle.

In the above embodiment, the guide holes 41A are formed in the rear end portions of the right and left side frames 41 of the movable frame 40. However, the present invention is not limited to this specific configuration, and the guide holes may be formed in the front end portions or the center portions of the right and left side walls (including the side walls of the pan frame 42 in the above embodiment) of the movable frame.

In the above embodiment, the movable frame 40 is moved and the base frame 30 is not moved in the frontal collision of the vehicle. However, the present invention is not limited to this specific configuration, and the base frame may be configured to be moved slightly with respect to the vehicle body in the event of the frontal collision of the vehicle.

In the above embodiment, the car seat is illustrated as an example of the vehicle seat. However, the vehicle seat according to the present invention is applicable to other vehicle seat, such as a seat for marine vessel and a seat for aircraft. Further, the vehicle body floor of the vehicle may be a body floor of the marine craft and the like. It is to be understood that the “front” used in the present invention refers to the front side of an occupant sitting on the seat. For this reason, in the case where the seat (occupant sitting on the seat) is disposed with its front side oriented backward in relation to the direction of movement of the vehicle, the backward direction in the direction of movement of the vehicle is considered to be the “front” side of the occupant. In this context, the frontal collision occurs, for example, when the vehicle is collided from behind.

In the above embodiment, the reinforcement pipe 45 made of one straight pipe is adopted by way of example. However, the reinforcement pipe is not limited to this straight member, and may be made of a curved member or two rods or pipes intersecting to form an X-shape.

In the above embodiment, the circular cylindrical connecting pipe 44 is adopted by way of example as the connecting member. However, the present invention is not limited to this specific configuration, and for example, a circular or rectangular solid-columnar connecting member may be used.

Further, a gas cylinder configured to expand outwardly in the right-left direction in the front collision of the vehicle may, be used as the driving force generator. In this case, the direction changing member may be rocking members configured to be rocked and push rods as the driving force transmission members in the front-rear direction when the rocking members are pressed outwardly in the right-left direction by the cylinder and the rod of the gas cylinder. Further, the direction changing member used in this case may be a combination of a wedge-shaped cam member configured to be pushed outward in the right-left direction by the gas cylinder and a member configured to be pushed in the front-rear direction by the slanted surface of the cam member.

In the above embodiment, the rotatable pulleys 53 are adopted by way of example as the direction changing member. However, the present invention is not limited to this specific configuration. For example, non-rotatable guide members each having a circular cylindrical surface such as a pin, around which the wire is looped, may be adopted. As an alternative, conventional tubular-shaped guides having an inner portion for inserting the wire may be adopted.

In the above embodiment, the circular cylindrical reinforcement pipe 54 is adopted as the reinforcement member. However, the present invention is not limited to this configuration, and a circular or rectangular solid-columnar reinforcement member or an X-shaped reinforcement member may be adopted.

In the above embodiment, the seatbelt is adopted as the occupant protection system. However, the present invention is not limited to this configuration, and for example, side air-bags configured to be moved in the frontal collision of the vehicle may be adopted.

In the above embodiment, the hexagonal bolt-shaped pins 94 are adopted by way of example as the attachment member. However, the present invention is not limited to this specific configuration, and for example, circular cylindrical pipes or circular cylindrical rods may be used. Further, in the above embodiment, the pins 94 are pivotably engaged with the base frame 30. However, the pins may be non-pivotably engaged. In this instance, pins may be prismatic columnar pipes or prismatic columnar rods.

In the above embodiment, the movable frame 40 (pan frame 42) has the recess portion 42A at a position opposite to the second gas cylinder 61. However, the present invention is not limited to this arrangement, and the movable frame 40 may have at least one opening (e.g., a hole or holes formed in the pan frame 42 or a space formed between two rod-like connecting members for connecting the right and left side frames 41) at a position opposite to the second gas cylinder 61. Further, in the above embodiment, the movable frame 40 has the recess portion 42A at underside of the movable frame 40. However, in the cases where the recess portion is provided above the movable frame or the movable frame has an opening, the second gas cylinder 61 may be disposed above the movable frame.

In the above embodiment, the pins 94 (attachment member) are engaged in the base frame 30 and the second gas cylinder 61 (driving force generator) and the guide holes 41A are provided in the movable frame 40. However, the present invention is not limited to this configuration, and the attachment member may be provided in the movable frame and the driving force generator and the guide holes may be provided in the base frame. As with the above embodiment, forming the guide holes 41A in the movable frame 40 makes it possible to maintain a sufficient rigidity for the base frame 30 as well as to reduce the weight of the movable frame 40, so that the movable frame 40 can be instantly and smoothly moved. Further, in the case where the attachment member is provided in the movable frame, instead of providing a separate part such as the pins 94 as described above, for example, the both end portions 44B of the connecting pipe 44 (connecting member) may be extended to provide a function similar to that of the pins 41. According to this configuration, the number of assembly parts of the car seat can be reduced.

In the above embodiment, the connecting pipe 44 (connecting member) is bent such that the center portion 44A thereof is positioned below the both end portions 44B. However, the present invention is not limited to this configuration, and the connecting member may be configured such that the center portion thereof is positioned rearwardly of the both end portions. As an alternative, the connecting member may be configured such that the center portion thereof is positioned below and rearwardly of the both end portions.

In the above embodiment, the second gas cylinder 61 is arranged at the movable frame 40 (under the pan frame 42). However, the second gas cylinder 61 may be arranged at the base frame 30. In this case, one end and the other end of the second wire 62 extending out from the second gas cylinder 61 may be connected to any portions of the movable frame 40. This makes it possible to transmit the driving force of the second gas cylinder 61 to the movable frame 40.

In the above embodiment, the circular cylindrical pipe is adopted by way of example as a member for connecting the right and left side frames or the links. However, the member for connecting the right and left members is not limited to this configuration. For example, a circular or rectangular solid-columnar connecting member may be used.

### Second Embodiment

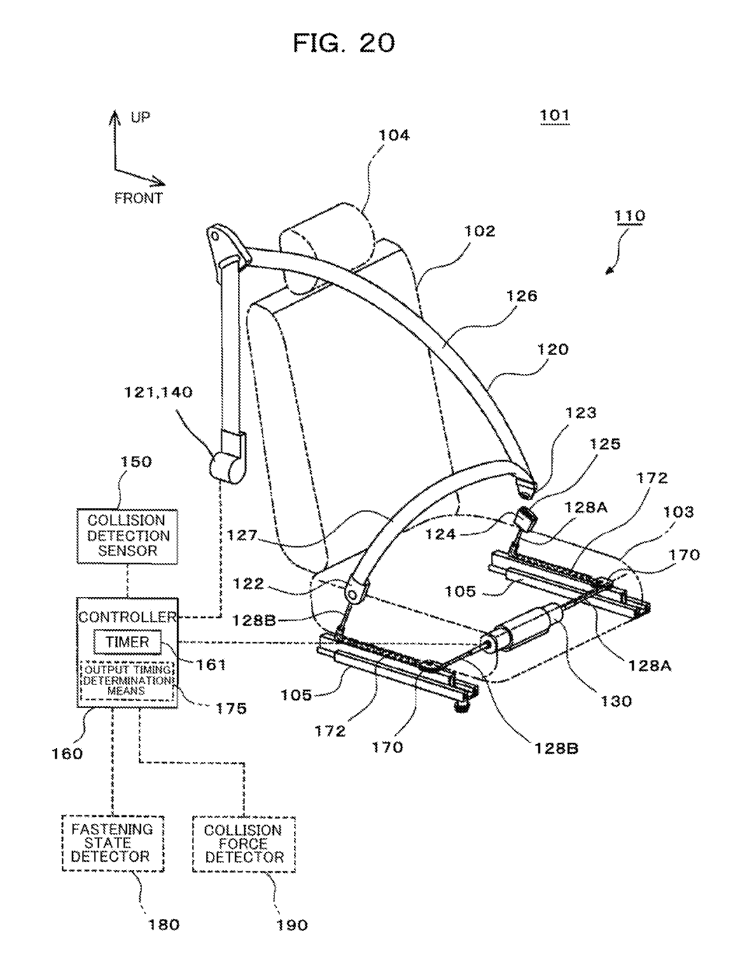

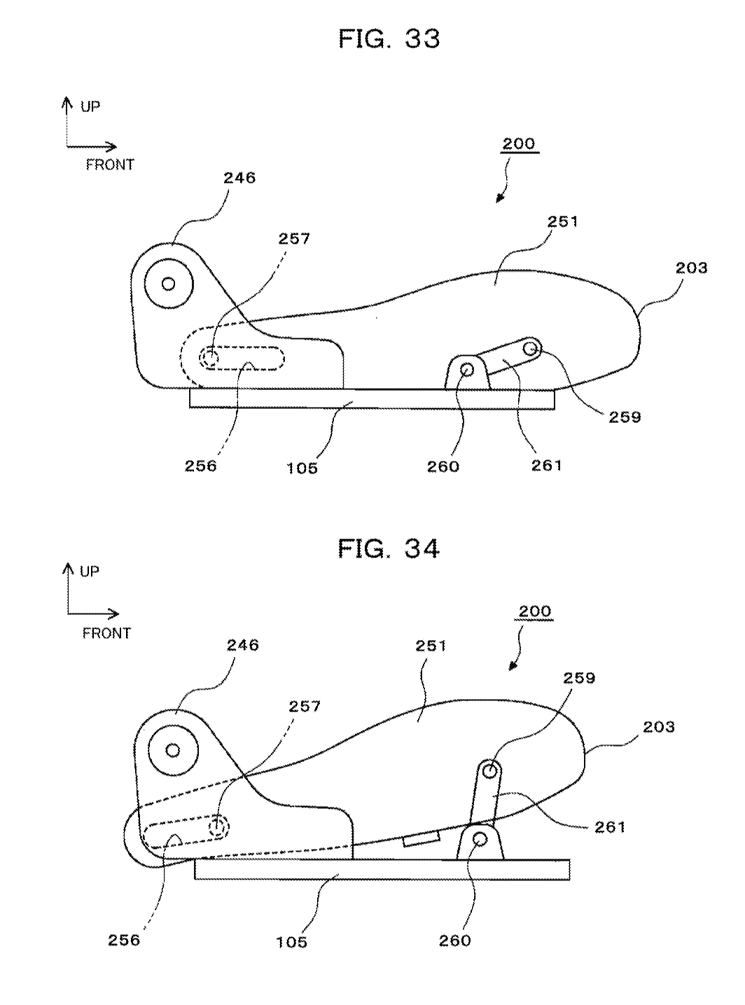

With reference to FIGS. 20-37, a second embodiment of the present invention will be described below.

The second embodiment may be implemented alone or in combination with the first embodiment.

In the following description, parts, arrangement and the like are not intended to limit the present invention, and as with the above first embodiment, various modifications may of course be made along the subject matter of the present invention.

According to the second embodiment, the occupant protection system is a seatbelt, which includes a shoulder belt designed to secure a shoulder part to a waist part of an occupant sitting on the car seat and a lap belt designed to secure the waist part of the occupant.

For example, Japanese Laid-open Patent Application, Publication No. 2003-1523922 discloses a technique for simultaneously activating a pyrotechnical shoulder pretensioner device and a pyrotechnical lap pretensioner device in a collision of the vehicle; the pyrotechnical shoulder pretensioner device is configured to pull the shoulder belt in a direction in which the occupant is secured by the shoulder belt, and the pyrotechnical lap pretension device is configured to pull the lap belt in a direction in which the occupant is secured by the lap belt.

According to this occupant protection system, since the shoulder pretensioner device and the lap pretensioner device are simultaneously activated in a collision of the vehicle, the shoulder belt and the lap belt are pulled in different directions by these pretensioner devices.

For the purpose of easing a tight fit of the shoulder belt experienced by an occupant, the occupant is generally fastened by the shoulder belt with a certain play (slack).

For this reason, when the shoulder pretensioner device and the lap pretensioner device are activated at the same time in a collision of the vehicle, the play of the shoulder belt that should be pulled by the shoulder pretensioner device is pulled by the lap pretensioner device. Therefore, the amount of the shoulder belt pulled by the shoulder pretensioner device decreases by an amount of the shoulder belt pulled by the lap pretensioner device, and the effective length of the shoulder belt required for seeming the upper body of the occupant becomes longer. This may disadvantageously decrease the securing force of the shoulder belt by which the upper body of the occupant is secured on the seat in a collision of the vehicle. If the amount of action of the lap pretensioner device is increased to solve this problem, the size of the device will be disadvantageously increased.

On the contrary, the lap pretensioner device pulls part of the shoulder belt corresponding to the play that should be pulled by the shoulder pretensioner device as described above, so that the pulling amount achieved by the lap pretensioner device increases by the pulling amount of the shoulder belt.

In general, a pyrotechnical pretensioner device has characteristics such that the pulling force for pulling the seatbelt is the greatest at an initial state of the operation and the pulling force gradually lowers with an increase in the amount of pulling the seatbelt. Therefore, if the lap pretensioner device pulls the part of the shoulder belt corresponding to the play thereof, the pulling force applied from the lap pretensioner device to the lap belt decreases accordingly. As a result, it is not said that the pulling force for the lap belt efficiently acts on the waist part of the occupant in the collision of the vehicle.

The second embodiment of the present invention seeks to provide an occupant protection system and a vehicle seat equipped with the occupant protection system, which can quickly remove a play of the seatbelt (slack) in a collision of the vehicle and reliably secure the occupant against the seat without increasing the size of the device.

### Overall Configuration

As seen in FIG. 20, a car seat 101 as an example of a vehicle seat of the present invention includes a backrest 102 of the car seat 101, a seat bottom 103, a head rest 104 provided at an upper part of the backrest 102, slide rails 105 for allowing the car seat 101 to be moved with respect to the car body, and an occupant restraint system 110 as an example of an occupant protection system.

As seen in this figure, the occupant restraint system 110 includes: a seatbelt 120 having a shoulder belt 126 and a lap belt 127; a lap pretensioner device 130 which is an example of a first driving force generator and configured to apply a tension to the lap belt 127; a shoulder pretensioner belt 140 configured to apply a tension to the shoulder belt 126; a collision detection sensor 150 configured to detect a collision of the vehicle; and a controller 160 configured to output an operation start signal to the shoulder pretensioner device 140 and the lap pretensioner device 130, respectively, when the collision detection sensor 150 detects a collision of the vehicle. The collision detection sensor 150 corresponds to a collision detector.

As seen in FIGS. 20-22, the seatbelt 120 has one end connected to a belt retractor 121 provided on the car body or the car seat 101 and the other end coupled to an anchor plate 122. A tongue plate 123 is provided at an intermediate portion of the seatbelt 120, and the tongue plate 123 is disengageably engageable with an inner buckle 125 of an inner lap anchor 124 which is provided as a pair together with the anchor plate 122. The tongue plate 123 is movable with respect to the seatbelt 120; however, in the cases where the seatbelt 120 is pulled out in the normal use and the like, the tongue plate 123 is not moved relative to the seatbelt 120. The anchor plate 122, the tongue plate 123, and the inner lap anchor 124 correspond to a stopper portion, an attachment portion, and an engagement portion, respectively.

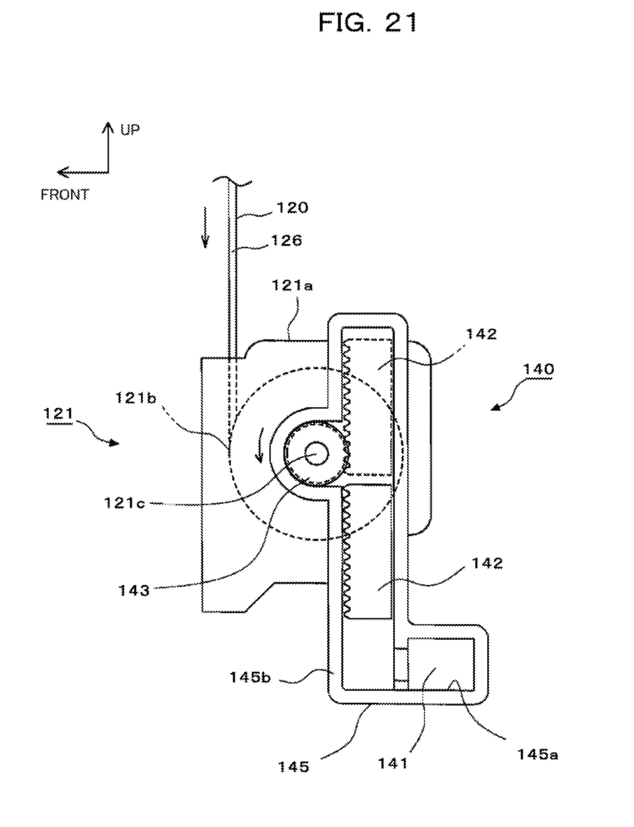

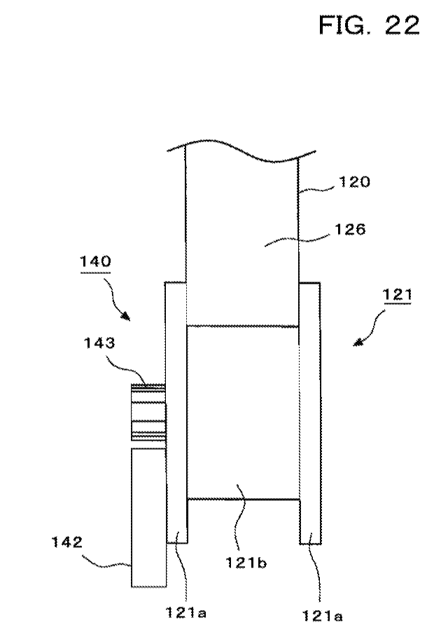

As seen in FIGS. 21 and 22, the belt retractor 121 includes side plates 121a disposed opposite to each other in the front-rear direction of the vehicle with a predetermined gap interposed therebetween, and a spool 121b rotatably supported on a drive shaft 121c which is provided between the side plates 121a along the front-rear direction of the vehicle. The one end of the seatbelt 120 is connected to the spool 121b, so that when the spool 121b is driven to rotate, the seatbelt 120 is wound up.

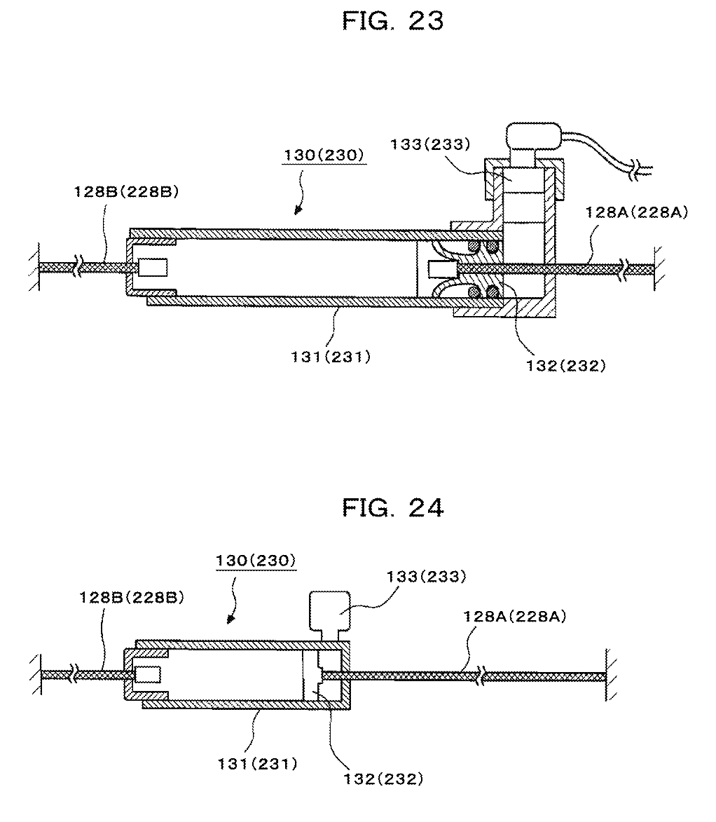

As seen in FIG. 20, a pair of right and left wire cables 128B, 128A as an example of a first driving force transmission member are connected at their one ends to a base portion of the anchor plate 122 and a base portion of the inner lap anchor 124, respectively. To be described later, the other end of the wire cable 128A and the other end of the wire cable 128E are fixed to the lap pretensioner device 130 (see FIGS. 23 through 26).

The seatbelt 120 is configured such that, in a state where the tongue plate 123 is engaged with the inner buckle 125, part of the seatbelt 120 extending from the one end to the tongue plate 123 forms a shoulder belt 126 whereas part of the seatbelt 120 extending from the tongue plate 123 to the anchor plate 122 forms a lap belt 127. The shoulder belt 126 principally secures the shoulder part to the waist part of the occupant seated on the car seat 101 when the shoulder pretensioner device 140 is activated. The lap belt 127 principally secures the waist part of the occupant seated on the car seat 101 when the lap pretensioner device 130 is activated.

As seen in FIGS. 20 and 23-26, the lap pretensioner device 130 includes a cylinder 131 and a piston 132 configured to be slidable in the cylinder 131; the piston 132 is caused to move in the cylinder 131 by gas pressure generated by explosion in the gas generator 133. The piston 132 corresponds to a movable member.

The lap pretensioner device 130 is disposed such that the towing direction of the wire cables 128A, 128B and the axis of the cylinder 131 are parallel to each other with respect to the car body, and the cylinder 131 is disposed movably in the axial direction of the lap pretensioner device 130. The lap pretensioner device 130 is fixed to the car seat 101 under the seat bottom 103.

As seen in FIGS. 23-25; the gas generator 133 is provided outside the cylinder 131, and produces a large amount of gas for moving the piston 132. The structure of the gas generator 133 is well known in the art; gas generating agent (explosive) for generating gas is stored inside the gas generator 133 and an ignition portion (not shown) for igniting the gas generating agent is provided.

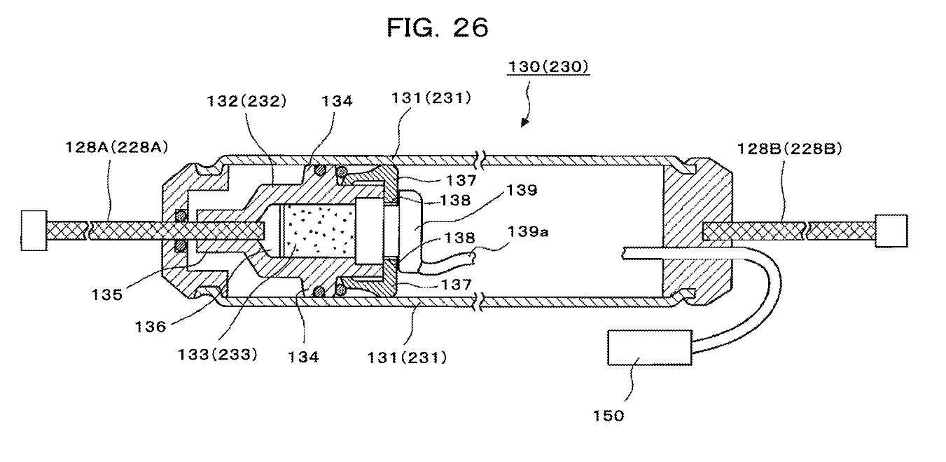

As an alternative, as seen in FIG. 26, the gas generator 133 may be disposed inside the cylinder 131. According to the lap pretensioner device 130 shown in FIG. 26, the gas generator 133 is provided in the piston 132. The piston 132 has a large-diameter portion 134 slidably contacting the inner periphery of the cylinder 131, and a cable fixing portion 135 for the engagement of the wire cable 128A is provided at one side of the large-diameter portion 134. The large-diameter portion 134 has a tubular configuration, and the gas generator 133 is hermetically inserted from the other side of the large-diameter portion 134 and fixed to the large-diameter portion 134.

The large-diameter portion 134 of the piston 132 has a gas exhaust port 136 at one side thereof, and a retaining cap 137 for the gas generator 133 is attached to the other side of the large-diameter portion 134. The cap 137 has a through-opening 138 at a predetermined position, through which a coupler 139 is joined to the gas generator 133. A harness 139a connected to the coupler 139 is further connected to the collision detection sensor 150. When the collision detection sensor 150 detects a collision of the vehicle, the gas generator 133 activates the ignition portion to perform ignition so that a large amount of gas is produced. This large amount of gas causes the gas pressure in the cylinder 131 at one side of the piston 132 to be increased through the gas exhaust port 136. The piston 112 instantaneously moves with an increase in the gas pressure to thereby pull in the wire cables 128A, 128B.

As seen in FIGS. 20 and 23-27, the other end of the wire cable 128A is connected to the piston 132 disposed in the cylinder 131 of the lap pretensioner device 130, and the other end of the wire cable 128B is connected to an end portion of the cylinder 131. Alternatively, the other end of the wire cable 128A may be connected to the end portion of the cylinder 131 while the other end of the wire cable 128B is connected to the piston 132.

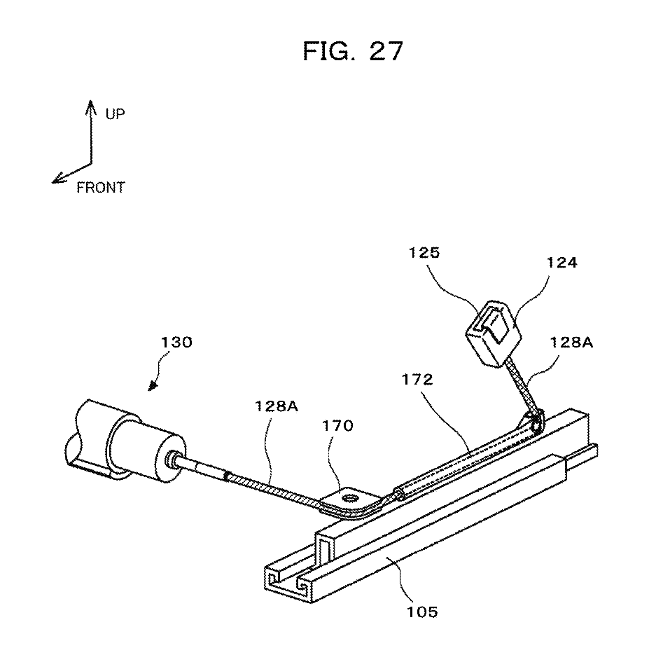

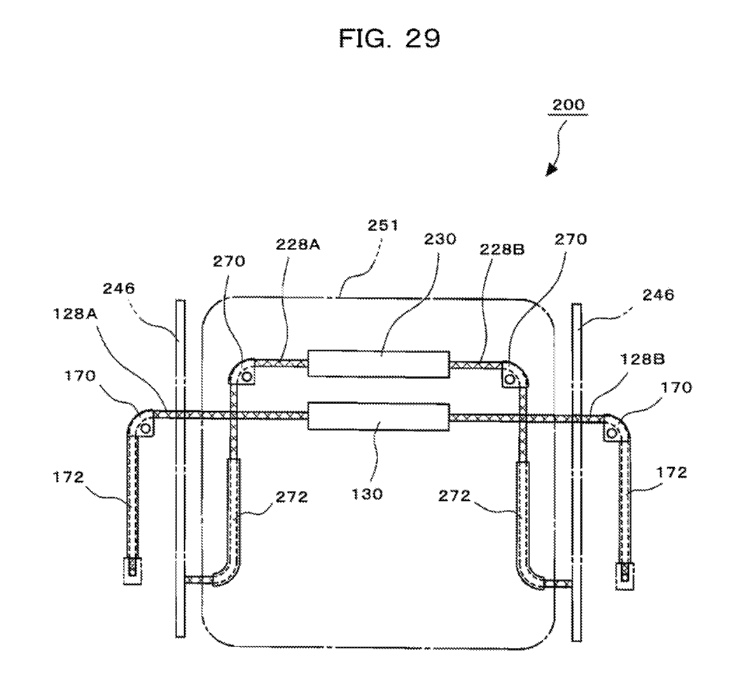

As seen in FIGS. 20 and 27, cable guides 170 (see FIG. 29) as a first direction changing member are provided at an intermediate position between the cylinder 131 and the anchor plate 122 and at an intermediate position between the cylinder 131 and the inner lap anchor 124; the cable guides 170 are configured to change the moving direction of the wire cables 128A, 128B (i.e., in the vehicle width direction) by the cylinder 131 and the piston 132 into the front-rear direction of the vehicle. Further, cable guides 172 substantially in the shape of a circular cylinder are provided between the cable guide 170 and the anchor plate 122 and between the cable guide 170 and the inner lap anchor 124; the cable guides 172 are configured to change the movement of the wire cables 128A, 128B in the front-rear direction of the vehicle into the upper-lower direction of the vehicle.

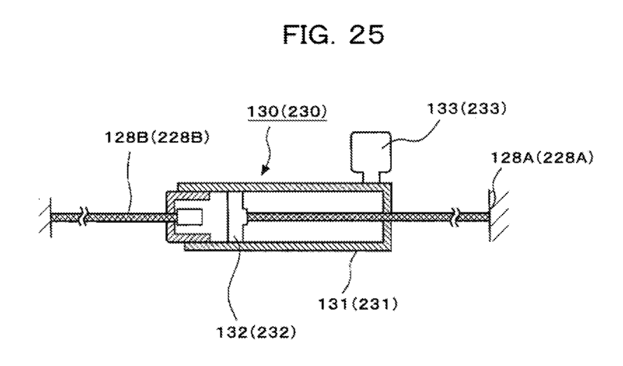

Next, operation of the lap pretensioner device 130 will be described with reference to FIGS. 24 and 25.

As seen in FIGS. 24 and 25, when the collision detection sensor 150 detects a collision of the vehicle and the lap pretensioner device 130 receives an operation start signal from the controller 160, the lap pretensioner device 130 ignites the gas generating agent. When the gas generating agent is ignited, a large amount of gas is produced from the gas generator 133 and the thus generated gas pressure causes the piston 132 to instantaneously move in the cylinder 131 in a predetermined direction. When the piston 132 moves, the reaction force acts on the cylinder 131, so that the piston 132 and the cylinder 131 are relatively moved in opposite directions.

As the piston 132 and the cylinder 131 move, the wire cable 128A connected to the piston 132 and the wire cable 128B connected to the cylinder 131 are substantially simultaneously pulled by the same amount. Accordingly, the lap belt 127 connected to the wire cables 128A, 128B is pulled by the two wire cables 128A, 128B so that the waist part of the occupant is principally secured against the car seat 101.

As seen in FIGS. 21 and 22, the shoulder pretensioner device 140 is attached to the side plates 121a of the belt retractor 121 at the front side of the vehicle. The shoulder pretensioner device 140 includes a gas generator 141, a rack 142, and a pinion 143. The gas generator 141 is received in a storage space 145a provided in a bottom portion of a housing 145, and when the gas generator 141 receives an operation start signal from the controller 160, the gas generator 141 ignites the gas generating agent (explosive) to produce gas. The housing 145 further includes a cylinder 145b extending in the upper-lower direction at a position above the storage space 145a and in communication with the storage space 145a. The rack 142 corresponds to the movable member.

The rack 142 is received in the cylinder 145b in such a manner as to be slidable in the upper-lower direction, and when the lower surface of the rack 142 receives the gas pressure from the gas generator 141, the rack moves upward from its normal position to a predetermined position that is a position higher than the normal position.

The pinion 143 is rotatably supported on the drive shaft 121c, and when the rack 142, moves from the normal position to the predetermined position, the pinion 143 is caused to mesh with the rack 142 and rotate counter-clockwise. With this rotation of the pinion 143, the spool 121b and the drive shaft 121c rotate in the same direction as that of the pinion 143, so that a predetermined amount of shoulder belt 126 is wound up by the spool 121b.

Next, operation of the shoulder pretensioner device 140 will be described.

When the collision detection sensor 150 detects a collision of the vehicle and the shoulder pretensioner device 140 receives an operation start signal from the controller 160, the shoulder pretensioner device 140 ignites the gas generating agent. When the gas generating agent is ignited, a large amount of gas is produced from the gas generator 141 and the thus generated gas pressure causes the rack 142 to instantaneously move upward. With this movement of the rack 142, the pinion 143, the spool 121b, and the drive shaft 121c rotate counter-clockwise, so that a predetermined amount of the shoulder belt 126 is wound up by the spool 121b. Accordingly, the shoulder belt 126 is pulled, so that the shoulder belt 126 principally secures the shoulder part to the waist part of the occupant against the car seat 101.

As seen in FIG. 20, the collision detection sensor 150 is attached to a predetermined position of the vehicle. The collision detection sensor 150 is configured to detect deceleration when abrupt deceleration occurs due to a collision of the vehicle. The collision detection sensor 150 is made of a deceleration sensor (acceleration sensor). When the collision detection sensor 150 detects abrupt deceleration of the vehicle such as a frontal collision or a lateral collision of the vehicle, the collision detection sensor 150 outputs a collision signal to the controller 160. Various detectors capable of detecting a collision of the vehicle may be adopted as the collision detection sensor 150, and for example, a deceleration (acceleration) sensor, a contact sensor, and a distance sensor may be employed.

The controller 160 is, for example, made of an ECU (Electric Control Unit) and includes a CPU, a ROM and a RAM. Further, the controller 160 has a timer 161 configured to measure time from when the operation start signal is output to the shoulder pretensioner device 140.

The controller 160 outputs an operation start signal to the lap pretensioner device 130 and the shoulder pretensioner device 140, respectively, when the controller 160 receives a collision signal from the collision detection sensor 150. The lap pretensioner device 130 and the shoulder pretensioner device 140 ignite the gas generating agent upon receipt of the operation start signals respectively from the controller 160, so that the shoulder belt 126 and the lap belt 127 are pulled in.

### Operation

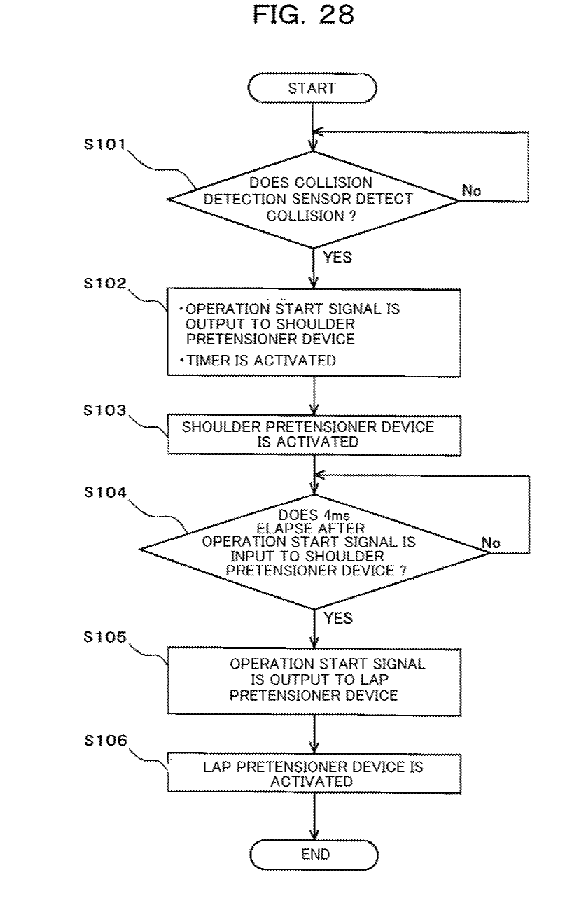

With reference to FIG. 28, operation of the occupant restraint system in a collision of the vehicle will be described.

As seen in FIG. 28, this operation control is initiated when the occupant is seated on the car seat 101 of the vehicle and then fastens the seatbelt 120.

Once the control is initiated, the controller 160 determines in step S101 whether the collision signal has been input from the collision detection sensor 150. If the controller 160 determines that the collision signal has been input from the collision detection sensor 150 in step S101 (S101; YES), the operation proceeds to step S102, and the controller 160 outputs the operation start signal to the shoulder pretensioner device 140 and at the same time activates the timer 161 (see FIG. 20).

On the contrary, if the controller 160 determines that the collision signal has not been input from the collision detection sensor 150 in step S101 (S101; NO), the determination in step S101 is repeated and the controller 160 stands by until the collision signal is input from the collision detection sensor 150.

When the process in the above step S102 is completed, the operation proceeds to step S103. In step S103, the shoulder pretensioner device 140 ignites the gas generating agent when it receives the operation start signal output in step S102. A large amount of gas is produced from the gas generator 141 when the gas generating agent is ignited, and the rack 142 instantaneously moves upward. This can cause the spool 121b to wind up the shoulder belt 126 by a predetermined amount to thereby pull the shoulder belt 126. When the shoulder belt 126 is pulled in, the shoulder belt 126 principally secures the shoulder part to the waist part of the occupant against the car seat 101 (see FIGS. 21 and 22).

When the process in step S103 is completed, the operation proceeds to step S104. In step S104, the controller 160 determines whether the elapsed time counted by the timer 161 that is activated in step S102 reaches 4 ms. If the controller 160 determines that the counting time of the timer 161 for 4 ms has elapsed in step S104 (S104; YES), the operation proceeds to step S105, and the controller 160 outputs the operation start signal to the lap pretensioner device 130. On the contrary, if the controller 160 determines that the counting time of the timer 161 for 4 ms has not elapsed in step S104 (S104; NO), the determination in step S104 is repeated and the controller 160 stands by until the counting time of the timer 161 reaches 4 ms.

When the process in the above step S105 is completed, the operation proceeds to step S106. In step S106, the lap pretensioner device 130 ignites the gas generating agent when it receives the operation start signal output in step S105. A large amount of gas is produced from the gas generator 133 when the gas generating agent is ignited, and the thus generated gas pressure causes the piston 132 to instantaneously move in the cylinder 131 in the predetermined direction. This can cause the piston 132 and the cylinder 131 to relatively move in opposite directions, so that the lap belt 127 is pulled in. When the lap belt 127 is pulled in, the lap belt 127 principally secures the waist part of the occupant against the car seat 101 (see FIGS. 20 and 23-26).

In this embodiment, the rate of acceleration is assumed to be 40 G (at the maximum) in the event of the collision of the vehicle, and the delay time from when the shoulder pretensioner device 140 initiates the operation to when the lap pretensioner device 130 initiates the operation is set to 4 ms. However, the delay time may vary where necessary and be set in different values.

To be more specific, it is preferable that the lap pretensioner device 130 initiates the operation when 3-5 ms elapses after the shoulder pretensioner device 140 initiates the operation.

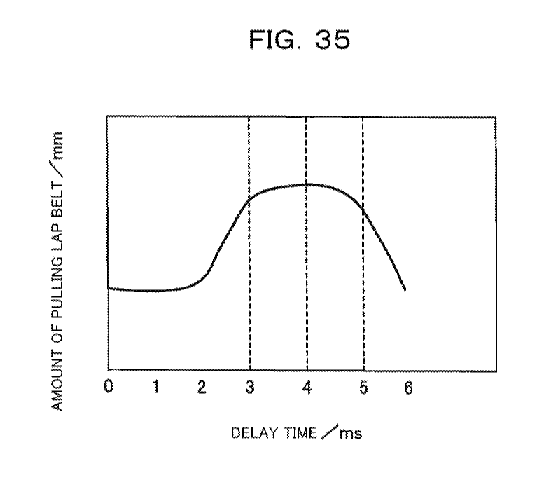

The inventor of this application conducted experiments for finding out the optimum timings (i.e., delay time) for activating the lap pretensioner device 130 with a delay after the shoulder pretensioner device 140 initiates the operation. The obtained experimental results were shown in FIG. 35.

In FIG. 35, the vertical axis indicates the amount of the lap belt 127 pulled by the lap pretensioner device 130 in the event of the collision of the vehicle, and the horizontal axis indicates the delay time from when the shoulder pretensioner device 140 initiates the operation to when the lap pretensioner device 130 initiates the operation.

As seen in FIG. 35, the amount of the lap belt 127 pulled by the lap pretensioner device 130 increases abruptly when the delay time is in the range of 2-3 ms, and takes the maximum value when the delay time is 4 ms. Further, the amount of the lap belt 127 pulled by the lap pretensioner device 130 decreases moderately when the delay time is in the range of 4-5 ms, and then decreases abruptly after the delay time of 5 ms.

In this way, it is considered that if the lap pretensioner device 130 initiates the operation before the elapse of 3 ms, the operation of the lap pretensioner device 130 will start before the play of the shoulder belt 126 has not been sufficiently pulled by the shoulder pretensioner device 140, so that the lap pretensioner device 130 will not sufficiently pulls in the lap belt 127.

On the contrary, if the lap pretensioner device 130 initiates the operation after the delay time of 5 ms, the occupant will be thrust frontwardly by the inertia force due to collision of the vehicle before the lap pretensioner device 130 starts to pull the lap belt 127. Therefore, even if the lap pretensioner device 130 thereafter initiates the operation, the lap belt 127 will not appropriately secure the occupant against the seat. It is therefore considered that the lap pretensioner device 130 will not sufficiently pulls in the lap belt 127.

As described above, the findings obtained indicate that setting the delay time in the range of 3-5 ms enables the shoulder belt 126 to reliably secure the occupant against the seat. It is preferable that the delay time is set to 4 ms, at which the amount of the lap belt 127 pulled by the lap pretensioner device 130 takes the maximum value.

### Advantageous Effects

As described above, according to the occupant restraint system 110 of this embodiment, when the collision detection sensor 150 detects a collision of the vehicle, at first the shoulder pretensioner device 140 starts to pull the shoulder belt 126. Thereafter, when 4 ms elapses after the shoulder pretensioner device 140 initiates the operation, the lap pretensioner device 130 initiates the operation. Namely, since the amount of the shoulder belt 126 pulled by the shoulder pretensioner device 140 is increased, the effective length of the shoulder belt 126 can be decreased. Accordingly, it is possible to improve the securing force of the shoulder belt 126, which is required to secure the upper body of the occupant against the seat in a collision of the vehicle.

Further, since the lap pretensioner device 130 is activated after the shoulder pretensioner device 140 starts to pull the shoulder belt 126, the pulling amount achieved by the lap pretensioner device 130 can be decreased. Accordingly, since the pulling force of the lap pretensioner device 130 for pulling the lap belt 127 can be improved, it is possible to improve the securing force of the lap belt 127, which is required to secure the waist part of the occupant against the seat in a collision of the vehicle.

As described above, according to the occupant restraint system of this embodiment, play (slack) of the shoulder belt can be quickly removed with a simple configuration and the occupant is reliably secured to the seat in a collision of the vehicle.

Further, the lap pretensioner device 130 includes the cylinder 131, and a piston 132 disposed in the cylinder 131 and configured to be moved in the cylinder 131 by gas pressure produced by explosion in the gas generator 133. The shoulder pretensioner device 140 includes the cylinder 145b, and the rack 142 disposed in the cylinder 145b and configured to be moved in the cylinder 145b by gas pressure produced by explosion in the gas generator 141. And tensions are applied to the shoulder belt 126 and the lap belt 127, respectively, by the movements of the piston 132 and the rack 142. Accordingly, since the movements of the piston 132 and the rack 142 by the gas pressure cause the shoulder belt 126 and the lap belt 127 to be pulled instantaneously and with a large movement amount, with a simple configuration, the occupant is more reliably secured to the car seat 101 in the event of the collision of the vehicle.

The lap pretensioner device 130 is connected both to the anchor plate 122 which is coupled to one end of the lap belt 127 and to the inner buckle 125 which is disengageably engageable with the tongue plate 123 provided at one end of the shoulder belt 126 and at the other end of the lap belt 127, and the lap pretensioner device 130 is configured to cause the anchor plate 122 and the inner buckle 125 to be moved substantially simultaneously based on the operation start signal from the controller 160 so as to apply a tension to the lap belt 127. Therefore, the anchor plate 122 and the inner buckle 125 positioned on both sides of the car seat 101 in the vehicle width direction can be moved substantially simultaneously in the direction of securing the occupant, so that the lap belt 127 can reliably secure the waist part of the occupant to the car seat 101 upon collision of the vehicle.

Since the car seat 101 according to the present invention is equipped with the above-described occupant restraint system 110, it is possible to provide the car seat 101, which can reliably secure the occupant to the seat upon collision of the vehicle.

### First Modification

With reference to FIGS. 29-34, a first modification of the second embodiment will be described below.

The first modification as shown in FIGS. 29-34 further includes a seat-displacement device in addition to the occupant restraint system and the car seat with the occupant restraint system according to the second embodiment as described above, and the configuration thereof is substantially the same as that of the second embodiment, except for the seat-displacement device. Therefore, parts similar to those previously described in the second embodiment are denoted by the same reference numerals and duplicated description thereof will be omitted. Further, since a seat-displacement pretensioner device 230 to be described below has the same configuration as that of the above-described lap pretensioner device 130, explanation of the seat-displacement pretensioner device 230 will be given with reference to FIGS. 23-26 illustrating the lap pretensioner device 130.

As seen in FIGS. 29-32, a car seat 200 according to the first modification includes an occupant restraint system 110 and a seat-displacement device 210.

The seat-displacement device 210 includes a seat-displacement pretensioner device 230 as an example of a second driving force generator, a stationary frame 246 as an example of a base frame, and a seat 203 having a seat frame 251 as an example of a movable frame.

As seen in FIGS. 23-26, as with the lap pretensioner device 130, the seat-displacement pretensioner device 230 includes a cylinder 231, and a piston 232 slidably disposed in the cylinder 231 and configured to be moved in the cylinder 231 by gas pressure generated by explosion in a gas generator 233. When the collision detection sensor 150 detects a collision of the vehicle and the seat-displacement pretensioner device 230 receives the operation start signal from the controller 160, the seat-displacement pretensioner device 230 ignites the gas generating agent to start the operation. Since the other configurations of the seat-displacement pretensioner device 230 are the same as those of the lap pretensioner device 130, description thereof will be omitted.

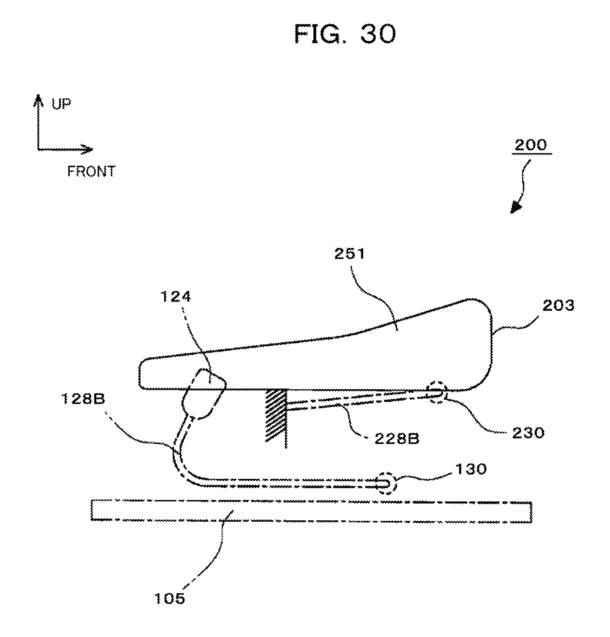

As seen in FIGS. 29 and 30, the seat-displacement pretensioner device 230 is fixed to a predetermined position in a bottom surface of a seat frame 251, and is arranged frontwardly of the cylinder 131 of the lap pretensioner device 130 in the front-rear direction of the vehicle. As described later, since the seat frame 251 is arranged along the front-rear direction of the vehicle with respect to the stationary frames 246, the seat-displacement pretensioner device 230 is configured to be movable in accordance with the movement of the seat frame 251.

Further, the seat-displacement pretensioner device 230 is arranged above the lap pretensioner device 130 and in such a position not to contact with the lap pretensioner device 130 when the seat-displacement pretensioner device 230 moves in accordance with the movement of the seat frame 251.

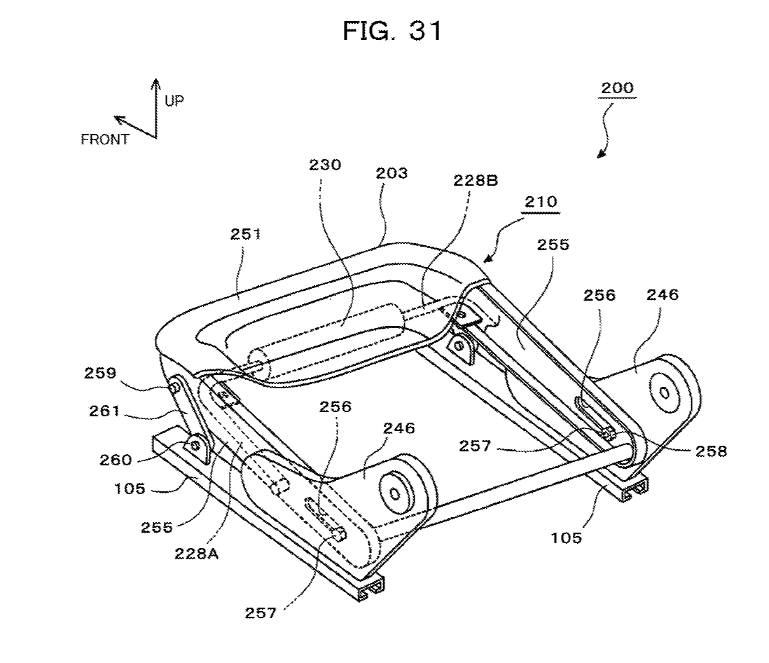

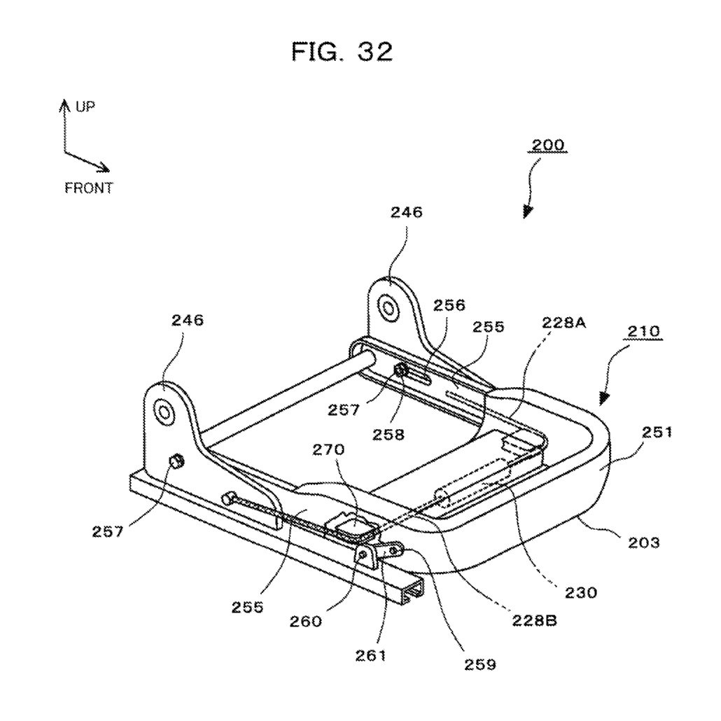

As seen in FIGS. 31 and 32, each of the stationary frames 246 is a generally plate-like member, and protrusively provided on the pair of slide rails 105 fixed to the car body. Each stationary frame 246 has a bolt insertion hole (not shown) for inserting a bolt 257 at a predetermined position located rearwardly in the front-rear direction of the vehicle.

One ends of the wire cables 228A, 2288 as a second driving force transmission member are connected to the stationary frames 246 at predetermined positions thereof; the other ends of the wire cables 228A, 228B are connected to the cylinder 231 and the piston 232 of the seat-displacement pretensioner device 230 (see FIGS. 23-26). The pair of wire cables 228A, 228B connect the cylinder 231 and the stationary frame 246 together and the piston 232 and the stationary frame 246 together, respectively, via the cable guides 270, 272 as a second direction changing member. Since the cable guide 270 and the cable guide 272 are the same in construction as the cable guide 170 and the cable guide 172 as shown in the second embodiment, description thereof will be omitted.

The seat frame 251 has oblong holes 256 formed along the front-rear direction of the vehicle at predetermined positions located in the side surfaces of the pair of right and left side members 255. The seat frame 251 is disposed between the pair of stationary frames 246 and attached to the stationary frames 246 with the bolts 257 being inserted into the bolt insertion holes of the stationary frames 246 and the oblong holes 256 and thereafter tightened by screwing the nuts 258. The seat frame 251 is configured to be movable in the front-rear direction of the vehicle with respect to the stationary frames 246; the seat frame 251 can be moved in a range where the bolts 257, which are tightened up by the nuts 258, slide along the oblong holes 256.

Further, each side member 255 of the seat frame 251 has a shaft 259 at a predetermined position located in the front side of the vehicle, and the seat frame 251 is attached to the slide rails 105 via link members 261, each of which is pivotably supported on the shaft 259 and on a shaft 260 provided on the slide rail 105. Accordingly, when the seat frame 251 slides rearwardly in the front-rear direction of the vehicle while being attached to the stationary frames 246 and the slide rails 105, the front side of the seat frame 251 is raised upward.

Next, with reference to FIGS. 23-26 and FIGS. 29-34, operation of the seat-displacement pretensioner device 230 will be described below.

As seen in FIGS. 23-26 and FIGS. 29-34, when the collision detection sensor 150 detects a collision of the vehicle and the seat-displacement pretensioner device 230 receives the operation start signal from the controller 160, the seat-displacement pretensioner device 230 ignites the gas generating agent (see FIG. 20). When the gas generating agent is ignited, a large amount of gas is produced from the gas generator 233 and the thus generated gas pressure causes the piston 232 to instantaneously move in the cylinder 231 in a predetermined direction. When the piston 232 moves, the reaction force acts on the cylinder 231, so that the cylinder 231 and the piston 232 are relatively moved in opposite directions.

As the cylinder 231 and the piston 232 move, the wire cable 228A connected to the piston 232 and the wire cable 228B connected to the cylinder 231 are substantially simultaneously pulled by the same amount. Accordingly, the seat frame 251 connected to the wire cables 228A, 228B via the seat-displacement pretensioner device 230 is instantaneously moved toward the rear-side of the vehicle with the front side of the seat frame 251 being gradually raised upward. By this way, since the seat frame 251 moves rearward in the event of the collision of the vehicle, it is possible to prevent the occupant from being sank down in a collision of the vehicle and to improve the securing effect for securing the occupant to the car seat 200. According to the first modification, when the seat frame 251 is moved rearward, the seat frame 251 is gradually raised upward at the front side thereof in accordance with the rearward movement of the seat frame 251. Therefore, it is possible to reliably prevent the occupant from being sank down upon collision of the vehicle.

In the first modification, the seat frame 251 is caused to move toward the rear-side of the vehicle at a timing when the collision detection sensor 150 detects the collision. However, the present invention is not limited to this configuration, and in accordance with the shape of the car seat and physiques of the occupant, etc., the seat frame 251 may be moved with a predetermined delay time after the collision detection sensor 150 detects the collision.

Further, in the first modification, when the seat frame 251 is moved toward the rear-side of the vehicle, the seat frame 251 is gradually raised upward at the front side thereof. However, the present invention is not limited to this configuration, and the seat frame 251 may be simply configured to be slidable substantially along the horizontal direction toward the rear side of the vehicle.

As described above, according to the first modification, when the collision of the vehicle is detected, the seat frame 251 is caused to move toward the rear-side of the vehicle in the front-rear direction, and at the same time, the operation of the shoulder pretensioner device 140 is initiated. Further, after a predetermined time elapses, the operation of the lap pretensioner device 130 is initiated. Therefore, according to the first modification, in addition to the above operational effects of the second embodiment, it is possible to prevent the occupant from being sank down upon collision of the vehicle. This can remarkably improve the securing effect for securing the occupant to the car seat 200.

### Second Modification

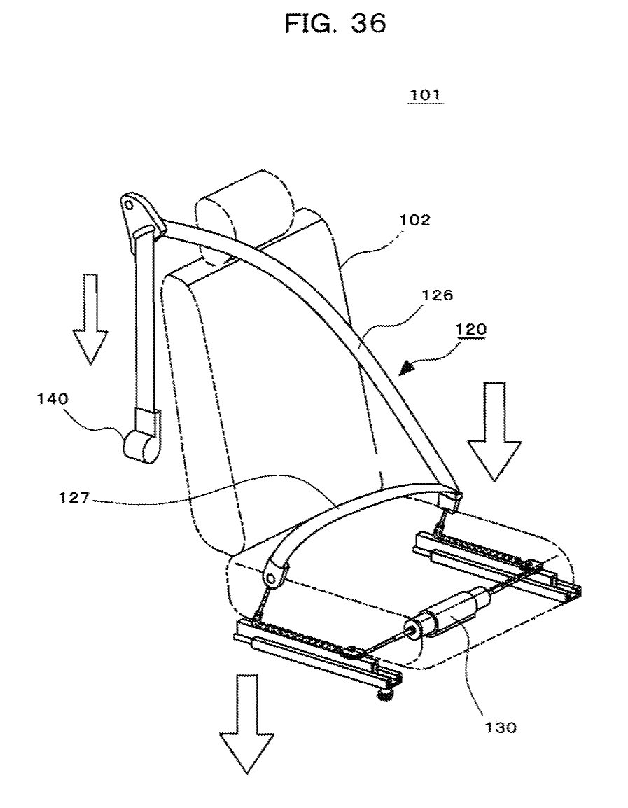

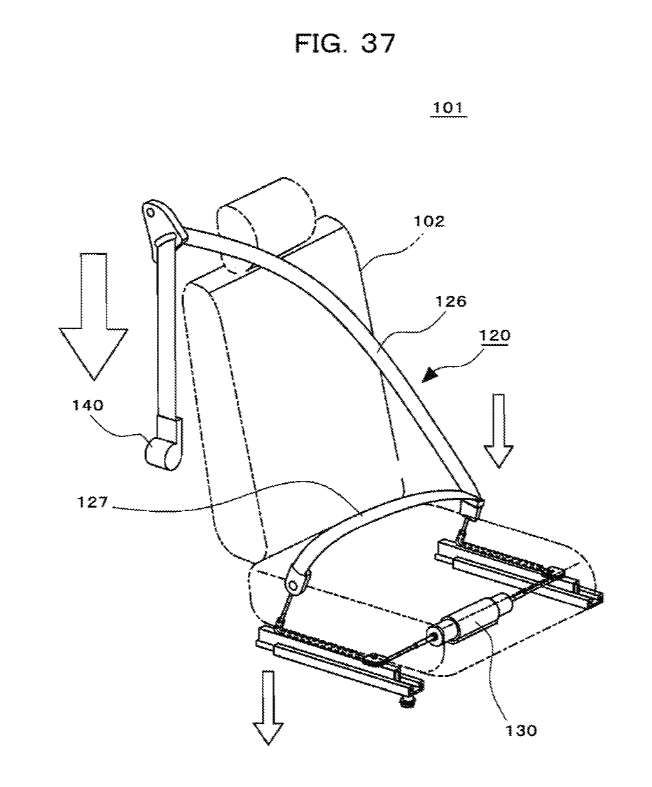

With reference to FIGS. 20, 36 and 37, a second modification of the second embodiment will be described below. FIGS. 36 and 37 are perspective views of the car seat equipped with the occupant restraint system, illustrating difference between pulling force applied by the shoulder pretensioner device and pulling force applied by the lap pretensioner device. The second modification as shown in FIGS. 20, 36 and 37 further includes an output timing determination means in addition to the occupant restraint system and the car seat with the occupant restraint system according to the second embodiment and the first modification as described above, and the configuration thereof is substantially the same as that of the second embodiment and the first modification, except for the output timing determination means. Therefore, parts similar to those previously described in the second embodiment and the first modification are denoted by the same reference numerals and duplicated description thereof will be omitted. Arrows shown in FIGS. 36 and 37 illustrate seatbelt pulling directions and seatbelt pulling force by the pretensioner devices.

As seen in FIG. 20, the controller 160 includes an output timing determination means 175 configured to determine output timings for outputting the operation start signals based on a difference between the pulling force of the shoulder pretensioner device 140 for pulling in the shoulder belt 126 and the pulling force of the lap pretensioner device 130 for pulling in the lap belt 127.

Data concerning the pulling force of the shoulder pretensioner device 140 and the pulling force of the lap pretensioner device 130 are input through an input means (not shown) such as a keyboard, and stored in advance in a storage means (not shown) such as a ROM provided in the controller 160.

The output timing determination means 175 determines a delay time from when the collision detection sensor 150 detects a collision to when the operation start signals are output to the lap pretensioner device 130 and the shoulder pretensioner device 140, respectively, based on the difference between the pulling force of the shoulder pretensioner device 140 and the pulling force of the lap pretensioner device 130 stored in the storage means.

For example, as seen in FIG. 36, in the case where the pulling force of the shoulder pretensioner device 140 for pulling the shoulder belt 126 is smaller than the pulling force of the lap pretensioner device 130 for pulling the lap belt 127, the output timing determination means 175 can set the delay time for the shoulder pretensioner device 140 to 0 ms and the delay time for the lap pretensioner device 130 to a predetermined time.

By this way, the delay time is determined by the output timing determination means 175 (see FIG. 20), and the controller 160 outputs the operation start signal to the shoulder pretensioner device 140 at the same time as the collision detection sensor 150 (see FIG. 20) detects the collision. Accordingly, the shoulder pretensioner device 140 starts to pull the shoulder belt 126 so that the play (slack) of the shoulder belt 126 is removed. Thereafter, the controller 160 outputs the operation start signal to the lap pretensioner device 130, so that the lap pretensioner device 130 starts to pull the lap belt 127.

As seen in FIG. 37, in the case where the pulling force of the shoulder pretensioner device 140 for pulling the shoulder belt 126 is greater than the pulling force of the lap pretensioner device 130 for pulling the lap belt 127, the output timing determination means 175 (see FIG. 20) can set the delay time for the lap pretensioner device 130 to 0 ms and the delay time for the shoulder pretensioner device 140 to a predetermined time (see FIG. 20).

By this way, the delay time is determined by the output timing determination means 175, and the controller 160 (see FIG. 20) outputs the operation start signal to the lap pretensioner device 130 at the same time as the collision detection sensor 150 detects the collision. Accordingly, the lap pretensioner device 130 starts to pull the lap belt 127 to thereby secure the waist part of the occupant against the car seat 101. Thereafter, the controller 160 outputs the operation start signal to the shoulder pretensioner device 140, so that the shoulder pretensioner device 140 starts to pull the shoulder belt 126.

As described above, according to the second modification, timings for pulling the shoulder belt 126 and the lap belt 127 can be set to different values where necessary based on the amounts of action of the shoulder pretensioner device 140 and the lap pretensioner device 130. Therefore, the shoulder belt 126 and the lap belt 127 can better secure the occupant against the seat in a collision of the vehicle.

In the above-described second embodiment and the first modification thereof, the so-called pyrotechnical pretensioner devices are used for the lap pretensioner device 130, the shoulder pretensioner device 140 and the seat-displacement pretensioner device 230. However, the present invention is not limited to this configuration, and electrically-operated pretensioner devices may be used, instead.

Further, as seen in FIG. 20, the occupant restraint system 110 may further include a fastening state detector 180 configured to detect a fastening state of the shoulder belt 126 and the lap belt 127 to the occupant. In this instance, the controller 160 may determine the timing for initiating the operation of the lap pretensioner device 130 based on the fastening state of the shoulder belt 126 and the lap belt 127 detected by the fastening state detector 180.

For example, a seat position sensor (hereinafter referred to as a “SPS”; not shown in the figures) may be attached to a predetermined position of the car seat 101 for the purpose of detecting the fastening state of the shoulder belt 126 and the lap belt 127 to the occupant; the SPS is configured to detect the displacement amount (seat position) of the car seat 101 with respect to the slide rails 105 (see FIG. 20). To be more specific, if the detection result of the SPS indicates that the car seat 101 is located at a frontward position of the vehicle, it is considered that the shoulder belt 126 and the lap belt 127 are tightly fastened to the occupant. For this reason, the delay time from when the shoulder pretensioner device 140 initiates the operation to when the lap pretensioner device 130 initiates the operation may be set to 3 ms.

A seat weight sensor (hereinafter referred to as a “SWS”; not shown in the figures) may be attached to a predetermined position of the car seat 101 for the purpose of detecting the fastening state of the shoulder belt 126 and the lap belt 127 to the occupant; the SWS is configured to detect the weight (body weight) of the occupant. To be more specific, if the detection result of the SWS indicates that the body weight of the occupant is 100 kg with respect to the reference body weight of the occupant which is set in advance to 70 kg, it is considered that the occupant is plump and that the shoulder belt 126 and the lap belt 127 are tightly fastened to the occupant. For this reason, the delay time from when the shoulder pretensioner device 140 initiates the operation to when the lap pretensioner device 130 initiates the operation may be set to 3 ms.

Further, an image capturing means for recognizing images of the occupant wearing the seatbelt, such as a video camera, may be installed in the car cabin, and the fastening state of the seatbelt may be detected based on a difference between a reference image that is acquired in advance as an image showing a normal fastening state of the occupant and an image showing the current actual fastening state of the occupant. To be more specific, if the occupant wears heavy clothes, the shoulder belt 126 is not tightly fastened to the occupant. For this reason, the delay time from when the shoulder pretensioner device 140 initiates the operation to when the lap pretensioner device 130 initiates the operation may be set to 5 ms. On the contrary, if the occupant wears light clothes, the delay time may be set to 3 ms because the shoulder belt 126 is tightly fastened to the occupant.

Therefore, since the delay time for initiating the operation of the lap pretensioner device 130 can be determined appropriately based on the fastening state of the shoulder belt 126 and the lap belt 127 to the occupant, in addition to the above operational effects of the second embodiment and the first modification, it is possible to more reliably secure the occupant to the seat upon collision of the vehicle.

Further, as seen in FIG. 20, the occupant restraint system 110 may further include a collision force detector 190 for detecting the collision force in the event of the collision of the vehicle. In this instance, the controller 160 may determine the timing for initiating the operation of the lap pretensioner device 130 based on the collision force of the vehicle detected by the collision force detector 190.

With this configuration, for example, in the case where the rate of acceleration in the collision of the vehicle is set to 40 G (at the maximum) as a reference value, and if the collision force of the vehicle is large, e.g., 50 G, it is necessary that the occupant be urgently secured by the seatbelt 120. For this reason, the delay time may be set to 3 ms.

Therefore, since the delay time for initiating the operation of the lap pretensioner device 130 can be determined appropriately based on the collision force of the vehicle, in addition to the above operational effects of the second embodiment and the first modification, it is possible to more reliably secure the occupant to the seat upon collision of the vehicle.

It is to be noted that, as seen in FIG. 20, the collision force detector 190 may be provided separately from the collision detection sensor 150 or the collision force detector 190 may also serve as the collision detection sensor 150. In the case where the collision force detector 190 is provided separately from the collision detection sensor 150, as with the collision detection sensor 150, various detectors for detecting a collision force of the vehicle may be adopted, and for example, a deceleration (acceleration) sensor, a contact sensor, and a distance sensor may be employed.

1. A vehicle seat configured such that a seating surface of a seat bottom moves in response to a frontal collision as defined with respect to an occupant seated on the vehicle seat, the vehicle seat comprising:
a base frame of the seat bottom configured to be supported on a vehicle body;
a movable frame configured to be movable relative to the base frame;
at least one driving force generator configured to be activated in response to the frontal collision; and
at least one driving force transmission member configured to transmit a driving force generated by the driving force generator,
wherein at least one of the driving force generator is arranged opposite to the movable frame, and the movable frame has a recess portion or an opening at a position opposite to the driving force generator.

2. The vehicle seat according to claim 1, wherein the driving force generator comprises a first driving force generator, and the driving force transmission member comprises a first driving force transmission member configured to transmit a driving force generated by the first driving force generator to an occupant protection system.

3. The vehicle seat according to claim 1, wherein the driving force generator comprises a second driving force generator, and the driving force transmission member comprises a second driving force transmission member configured to transmit a driving force generated by the second driving force generator between the base frame and the movable frame, whereby the movable frame is moved relative to the base frame.

4. The vehicle seat according to claim 1, wherein the driving force generator comprises a first driving force generator and a second driving force generator, and
wherein the driving force transmission member comprises:
a first driving force transmission member configured to transmit a driving force generated by the first driving force generator to an occupant protection system; and
a second driving force transmission member configured to transmit a driving force generated by the second driving force generator between the base frame and the movable frame whereby the movable frame is moved relative to the base frame.

5. The vehicle seat according to claim 1, wherein the driving force generator comprises:
a first driving force generator configured to contract in response to a frontal collision and provided at a portion which is not moved in a front-rear direction by the frontal collision with its axis oriented in a right-left direction; and
a second driving force generator configured to contract in response to the frontal collision and provided at the movable frame with its axis oriented in the right-left direction,
wherein the driving force transmission member comprises:
a first wire configured to connect one end and the other end of the first driving force generator to a seatbelt anchor and an inner buckle respectively; and
a second wire configured to connect one end and the other end of the second driving force generator to positions which are not moved in the front-rear direction by the frontal collision and which are disposed rearwardly of the second driving force generator, and
wherein the second driving force generator is disposed above the first driving force generator.

6. The vehicle seat according to claim 5, wherein the second driving force generator is arranged frontwardly of the first driving force generator.

7. The vehicle seat according to claim 5, wherein the movable frame is configured such that a front part thereof is moved upward when the movable frame is moved rearward relative to the base frame.

8. The vehicle seat according to claim 5, wherein each of the first driving force generator and the second driving force generator comprises a cylinder and a piston rod, and each cylinder is disposed in a position closer to one of right and left ends.

9. The vehicle seat according to claim 1, wherein the movable frame comprises right and left side frames, and a pan frame made of sheet metal and configured to connect front end portions of the right and left side frames,
wherein the driving force generator is provided on the movable frame, and the driving force transmission member is configured to transmit a driving force generated by the driving force generator to a portion other than the movable frame, whereby the movable frame is moved relative to the base frame, and
wherein the vehicle seat further comprises a direction changing member attached to the side frame and configured to change a direction of a force applied from the driving force transmission member.

10. The vehicle seat according to claim 9 comprising a reinforcement member configured to connect an attachment portion of the direction changing member and another portion to reinforce the attachment portion.

11. The vehicle seat according to claim 4 comprising first direction changing members provided separately at right and left sides and configured to change a direction of a force applied from the first driving force transmission member, and a reinforcement member configured to connect the right and left direction changing members.

12. The vehicle seat according to claim 11, wherein the first direction changing member is arranged in a space below the base frame.

13. The vehicle seat according to claim 3, wherein the movable frame has guide holes each formed in right and left side walls of the movable frame in such a manner as to extend in a front-rear direction along the side wall to guide a movement of the movable frame, and a connecting member configured to connect the right and left side walls of the movable frame, and
wherein both ends of the connecting member are connected to the right and left side walls of the movable frame in positions above or below the guide holes.

14. The vehicle seat according to claim 13 comprising attachment members respectively engageable with right and left side walls of the base frame, wherein each attachment members is inserted into the guide hole, and the driving force transmission member is connected to the attachment member.

15. The vehicle seat according to claim 13, wherein the connecting member is configured such that a center portion thereof curves from both end portions thereof in a direction away from the occupant.

16. The vehicle seat according to claim 1 comprising:
mounting brackets provided below and at right and left of the seat bottom so as to attach the seat bottom to the vehicle body;
right and left height adjustment links pivotably connected to the right and left mounting brackets and pivotably connected to the base frame; and
a connecting member configured to connect the right and left height adjustment links, wherein the connecting member is arranged below a moving trajectory of the movable frame.

17. The vehicle seat according to claim 16 comprising:
first and second driving force generators configured to be activated in response to the frontal collision;
a first driving force transmission member configured to transmit a driving force generated by the first driving force generator to a seatbelt to pull in the seatbelt;
first direction changing members provided at right and left of the first driving force generator and configured to change a direction of an applied force from the first driving force transmission member;
a second driving force transmission member configured to transmit a driving force generated by the second driving force generator between the base frame and the movable frame to thereby cause the movable frame to move relative to the base frame; and
second direction changing members provided at right and left of the second driving force generator and configured to change a direction of a force applied from the second driving force transmission member,
wherein the second direction changing members are disposed more inward in a right-left direction than the first direction changing members.

18. The vehicle seat according to claim 3 comprising seating surface position adjustment members each having one end portion pivotably connected to the movable frame and another end portion pivotably connected to the base frame, so that the seating surface position adjustment member is rotated when the movable frame is moved relative to the base frame,
wherein the seating surface position adjustment members are provided between side walls of the base frame and side walls of the movable frame.

19. The vehicle seat according to claim 18, wherein the driving force transmission member is disposed to extend in a front-rear direction between the side walls of the base frame and the side walls of the movable frame.

20. The vehicle seat according to claim 18, wherein each side wall of the movable frame has an upper fringe portion and a lower fringe portion to form a U-shaped cross-section at a portion facing to the driving force transmission member or the seating surface position adjustment member.

21. The vehicle seat according to claim 18, wherein each side wall of the base frame has an upper fringe portion and a lower fringe portion to form a U-shaped cross-section at a portion facing to the driving force transmission member or the seating surface position adjustment member.

22. The vehicle seat according to claim 2, wherein the occupant protection system is a seatbelt comprising a shoulder belt designed to secure a shoulder part to a waist part of the occupant sitting on the vehicle seat, and a lap belt designed to secure the waist part of the occupant,
wherein the first driving force generator is a lap pretensioner device configured to apply a tension to the lap belt, and
wherein the vehicle seat further comprises:
a shoulder pretensioner device configured to apply a tension to the shoulder belt;
a collision detector configured to detect a collision of a vehicle;
a controller configured to output an operation start signal to the shoulder pretensioner device and the lap pretensioner device, respectively, when the collision detector detects a collision of the vehicle; and
an output timing determination unit provided in the controller and configured to determine output timings for outputting the operation start signals based on a pulling force of the shoulder pretensioner device for pulling in the shoulder belt and a pulling force of the lap pretensioner device for pulling in the lap belt,
wherein the shoulder pretensioner device and the lap pretensioner device apply tensions to the shoulder belt and the lap belt based on the operation start signals determined by the output timing determination unit.

23. The vehicle seat according to claim 2, wherein the occupant protection system is a seatbelt comprising a shoulder belt designed to secure a shoulder part to a waist part of the occupant sitting on the vehicle seat, and a lap belt designed to secure the waist part of the occupant,
wherein the first driving force generator is a lap pretensioner device configured to apply a tension to the lap belt, and
wherein the vehicle seat further comprises:
a shoulder pretensioner device configured to apply a tension to the shoulder belt;
a collision detector configured to detect a collision of a vehicle; and
a controller configured to output an operation start signal to the shoulder pretensioner device and the lap pretensioner device, respectively, when the collision detector detects a collision of the vehicle,
wherein the shoulder pretensioner device applies a tension to the shoulder belt based on the operation start signal, and
wherein the lap pretensioner device applies a tension to the lap belt based on the operation start signal after initiation of an operation of the shoulder pretensioner device.

24. The vehicle seat according to claim 22, wherein the occupant protection system further comprises a fastening state detector configured to detect a fastening state of the shoulder belt and the lap belt to the occupant, and
wherein the controller determines a timing for initiating an operation of the lap pretensioner device in accordance with the fastening state of the shoulder belt and the lap belt detected by the fastening state detector.

25. The vehicle seat according to claim 23, wherein the occupant protection system further comprises a fastening state detector configured to detect a fastening state of the shoulder belt and the lap belt to the occupant, and
wherein the controller determines a timing for initiating an operation of the lap pretensioner device in accordance with the fastening state of the shoulder belt and the lap belt detected by the fastening state detector.
